(19) United States
(12) Patent Application Publication
(10) Pub. No.: US 2024/0340205 A1
(43) Pub. Date: Oct. 10, 2024

(54) GUARD PERIODS OR GAPS BETWEEN SYMBOLS OR SLOTS OR WITHIN A SLOT

(71) Applicant: QUALCOMM Incorporated, San Diego, CA (US)

(72) Inventors: Qian ZHANG, Basking Ridge, NJ (US); Yan ZHOU, San Diego, CA (US); Junyi LI, Fairless Hills, PA (US)

(21) Appl. No.: 18/296,129

(22) Filed: Apr. 5, 2023

(51) Int. Cl. H04L 27/26; H04L 5/00; H04W 72/0446

(52) U.S. Cl. CPC H04L 27/2607; H04L 5/0048; H04W 72/0446; H04L 5/14

(57) ABSTRACT

Various aspects of the present disclosure generally relate to wireless communication. In some aspects, a user equipment (UE) may perform a first communication in a first type of symbol or slot. The UE may perform a second communication in a second type of symbol or slot. A guard period or gap may be defined between the first type of symbol or slot and the second type of symbol or slot, or the guard period or gap may be defined within a slot corresponding to the first type of symbol or slot or the second type of symbol or slot, and the guard period or gap may be defined based at least in part on a reference symbol type switch boundary and a guard period or gap location. Numerous other aspects are described.

### FIELD OF THE DISCLOSURE

Aspects of the present disclosure generally relate to wireless communication and to techniques and apparatuses for guard periods or gaps between symbols or slots or within a slot.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some implementations, an apparatus for wireless communication at a user equipment (UE) includes a memory and one or more processors, coupled to the memory, configured to: perform a first communication in a first type of symbol or slot; and perform a second communication in a second type of symbol or slot, a guard period or gap being defined between the first type of symbol or slot and the second type of symbol or slot, or the guard period or gap being defined within a slot corresponding to the first type of symbol or slot or the second type of symbol or slot, and the guard period or gap being defined based at least in part on a reference symbol type switch boundary and a guard period or gap location.

In some implementations, an apparatus for wireless communication at a network node includes a memory and one or more processors, coupled to the memory, configured to: perform a first communication in a first type of symbol or slot; and perform a second communication in a second type of symbol or slot, a guard period or gap being defined between the first type of symbol or slot and the second type of symbol or slot, or the guard period or gap being defined within a slot corresponding to the first type of symbol or slot or the second type of symbol or slot, and the guard period or gap being defined based at least in part on a reference symbol type switch boundary and a guard period or gap location.

In some implementations, a method of wireless communication performed by a UE includes performing a first communication in a first type of symbol or slot; and performing a second communication in a second type of symbol or slot, a guard period or gap being defined between the first type of symbol or slot and the second type of symbol or slot, or the guard period or gap being defined within a slot corresponding to the first type of symbol or slot or the second type of symbol or slot, and the guard period or gap being defined based at least in part on a reference symbol type switch boundary and a guard period or gap location.

In some implementations, a method of wireless communication performed by a network node includes performing a first communication in a first type of symbol or slot; and performing a second communication in a second type of symbol or slot, a guard period or gap being defined between the first type of symbol or slot and the second type of symbol or slot, or the guard period or gap being defined within a slot corresponding to the first type of symbol or slot or the second type of symbol or slot, and the guard period or gap being defined based at least in part on a reference symbol type switch boundary and a guard period or gap location.

In some implementations, a non-transitory computer-readable medium storing a set of instructions for wireless communication includes one or more instructions that, when executed by one or more processors of a UE, cause the UE to: perform a first communication in a first type of symbol or slot; and perform a second communication in a second type of symbol or slot, a guard period or gap being defined between the first type of symbol or slot and the second type of symbol or slot, or the guard period or gap being defined within a slot corresponding to the first type of symbol or slot or the second type of symbol or slot, and the guard period or gap being defined based at least in part on a reference symbol type switch boundary and a guard period or gap location.

In some implementations, a non-transitory computer-readable medium storing a set of instructions for wireless communication includes one or more instructions that, when executed by one or more processors of a network node, cause the network node to: perform a first communication in a first type of symbol or slot; and perform a second communication in a second type of symbol or slot, a guard period or gap being defined between the first type of symbol or slot and the second type of symbol or slot, or the guard period or gap being defined within a slot corresponding to the first type of symbol or slot or the second type of symbol or slot, and the guard period or gap being defined based at least in part on a reference symbol type switch boundary and a guard period or gap location.

In some implementations, an apparatus for wireless communication includes means for performing a first communication in a first type of symbol or slot; and means for performing a second communication in a second type of symbol or slot, a guard period or gap being defined between the first type of symbol or slot and the second type of symbol or slot, or the guard period or gap being defined within a slot corresponding to the first type of symbol or slot or the second type of symbol or slot, and the guard period or gap being defined based at least in part on a reference symbol type switch boundary and a guard period or gap location.

In some implementations, an apparatus for wireless communication includes means for performing a first communication in a first type of symbol or slot; and means for performing a second communication in a second type of symbol or slot, a guard period or gap being defined between the first type of symbol or slot and the second type of symbol or slot, or the guard period or gap being defined within a slot corresponding to the first type of symbol or slot or the second type of symbol or slot, and the guard period or gap being defined based at least in part on a reference symbol type switch boundary and a guard period or gap location.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating examples of full duplex communications, in accordance with the present disclosure.

FIG. 5 is a diagram illustrating examples of full duplex communications, in accordance with the present disclosure.

FIG. 6 is a diagram illustrating an example of a guard period/gap between symbols/slots, in accordance with the present disclosure.

FIGS. 7-11 are diagrams illustrating examples associated with guard periods/gaps between symbols/slots or within a slot, in accordance with the present disclosure.

FIGS. 12-13 are diagrams illustrating example processes associated with guard periods/gaps between symbols/slots or within a slot, in accordance with the present disclosure.

FIGS. 14-15 are diagrams of example apparatuses for wireless communication, in accordance with the present disclosure.

### DETAILED DESCRIPTION

A subband full duplex (SBFD) capable network node may configure resources with co-existing SBFD symbols/slots (symbols or slots) and non-SBFD/legacy downlink, uplink or flexible symbols/slots. When switching between the SBFD symbols/slots and the non-SBFD/legacy downlink, uplink or flexible symbols/slots, the network node and/or a UE may need a guard period/gap (a guard period or a gap) in between the SBFD symbols/slots and the non-SBFD/legacy downlink, uplink or flexible symbols/slots. The guard period/gap may allow the network node and/or the UE to retune certain radio frequency (RF)/baseband blocks or filters. The guard period/gap may enable an adjusted uplink UE timing advance (TA) for aligning a network node downlink and uplink timing with a TA offset (e.g., TA offset 0) for an SBFD slot (e.g., an adjusted uplink UE TA for inter-UE cross-link interference (CLI) mitigation for the SBFD slot). The guard period/gap may enable the UE to perform a downlink-to-uplink direction switch, which may allow the UE to switch an RF given that an uplink timing is advanced to a downlink direction. The guard period/gap may ensure that inter-cell interference at the network node from other cells (in the downlink direction) may be avoided before an uplink direction of the network node. The guard period/gap may allow for the network node to adapt different antenna configurations, such as antenna elements or transceiver units (TXRUs) for SBFD symbols/slots and non-SBFD/legacy downlink, uplink or flexible symbols/slots.

In some cases, a UE and/or a network node may not be configured for a guard period/gap between symbols/slots. For example, the UE and/or the network node may not be configured for the guard period/gap between SBFD symbols/slots and non-SBFD/legacy downlink, uplink or flexible symbols/slots. The UE and/or the network node may not be configured with an allowed type switch boundary and a guard gap/period location rule. As a result, the UE and/or the network node may be unable to perform an RF retuning, adjust a TA, perform a downlink-to-uplink direction switch, and/or adapt a different antenna configuration between different symbols/slots, which may degrade a performance of the UE and/or the network node.

In some aspects described herein, a UE or a network node may perform a first communication in a first type of symbol/slot. The UE or the network node may perform a second communication in a second type of symbol/slot. The first type of symbol/slot may be an SBFD symbol/slot, and the second type of symbol/slot may be a non-SBFD downlink, uplink, or flexible symbol/slot. Alternatively, the first type of symbol/slot may be the non-SBFD downlink, uplink, or flexible symbol/slot, and the second type of symbol/slot may be the SBFD symbol/slot. A guard period/gap may be defined between the first type of symbol/slot and the second type of symbol/slot, or the guard period/gap may be defined within a slot corresponding to the first type of symbol/slot or the second type of symbol/slot. The guard period/gap may be defined based at least in part on a reference symbol type switch boundary and a guard period or gap location. In other words, the guard period/gap may be defined based at least in part on an allowed type switch boundary and a guard gap/period location rule. As a result, the UE and/or the network node may use the guard period/gap to perform an RF retuning, adjust a TA, perform a downlink-to-uplink direction switch, and/or adapt a different antenna configuration between different symbols/slots, which may improve a performance of the UE and/or the network node.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

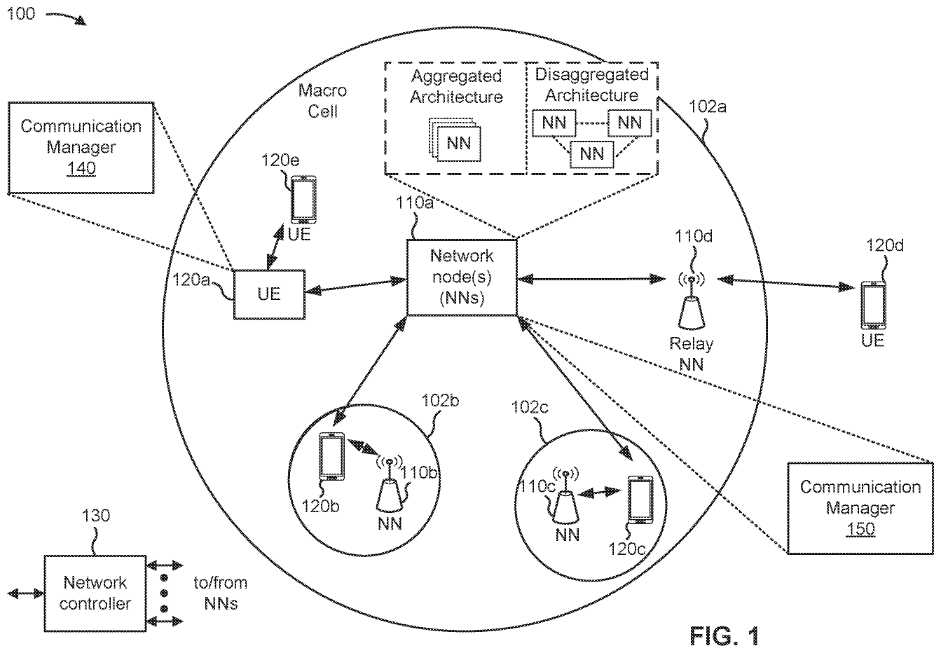

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120c), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120c) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V21) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHZ-52.6 GHZ). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHZ) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHZ. For example, three higher operating bands have been identified as frequency range designations FR4a or FR4-1 (52.6 GHZ-71 GHz), FR4 (52.6 GHZ-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., the UE 120) may include a communication manager 140. As described in more detail elsewhere herein, the communication manager 140 may perform a first communication in a first type of symbol/slot; and perform a second communication in a second type of symbol/slot, a guard period/gap being defined between the first type of symbol/slot and the second type of symbol/slot, or the guard period/gap being defined within a slot corresponding to the first type of symbol/slot or the second type of symbol/slot, and the guard period/gap being defined based at least in part on a reference symbol type switch boundary and a guard period/gap location. Additionally, or alternatively, the communication manager 140 may perform one or more other operations described herein.

In some aspects, a network node (e.g., the network node 110) may include a communication manager 150. As described in more detail elsewhere herein, the communication manager 150 may perform a first communication in a first type of symbol/slot; and perform a second communication in a second type of symbol/slot, a guard period/gap being defined between the first type of symbol/slot and the second type of symbol/slot, or the guard period/gap being defined within a slot corresponding to the first type of symbol/slot or the second type of symbol/slot, and the guard period/gap being defined based at least in part on a reference symbol type switch boundary and a guard period/gap location. Additionally, or alternatively, the communication manager 150 may perform one or more other operations described herein.

As indicated above, FIG. 1 is provided as an example. Other examples may differ from what is described with regard to FIG. 1.

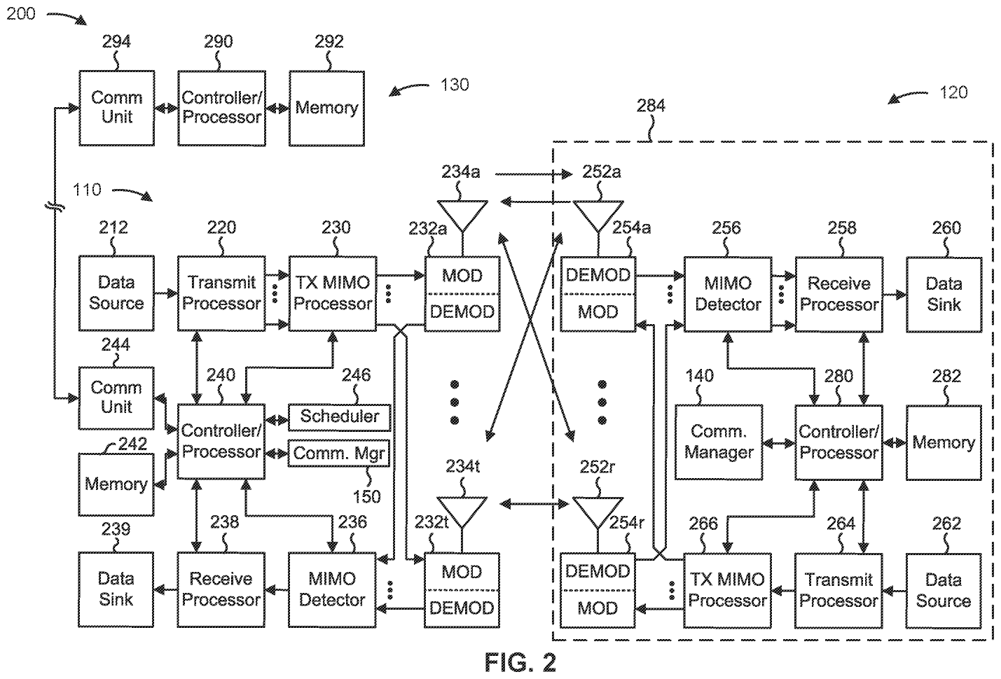

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

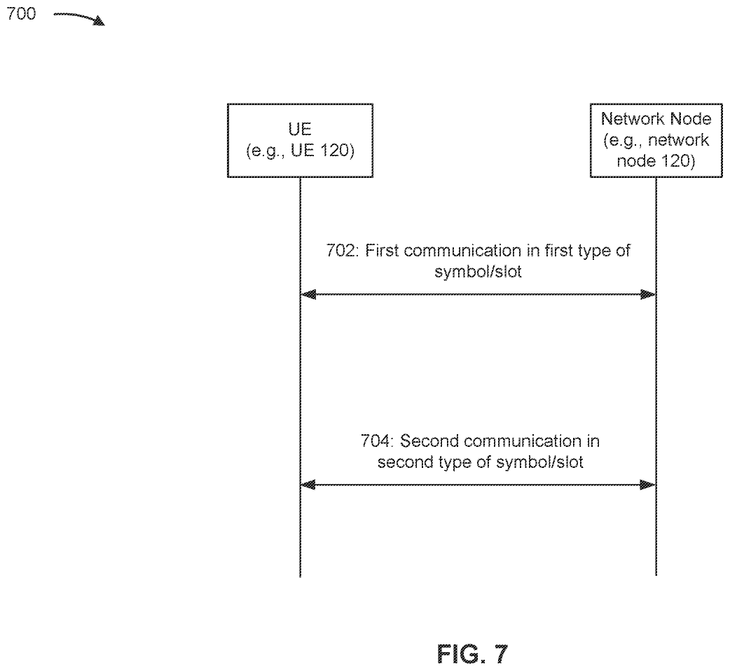

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 7-15).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 7-15).

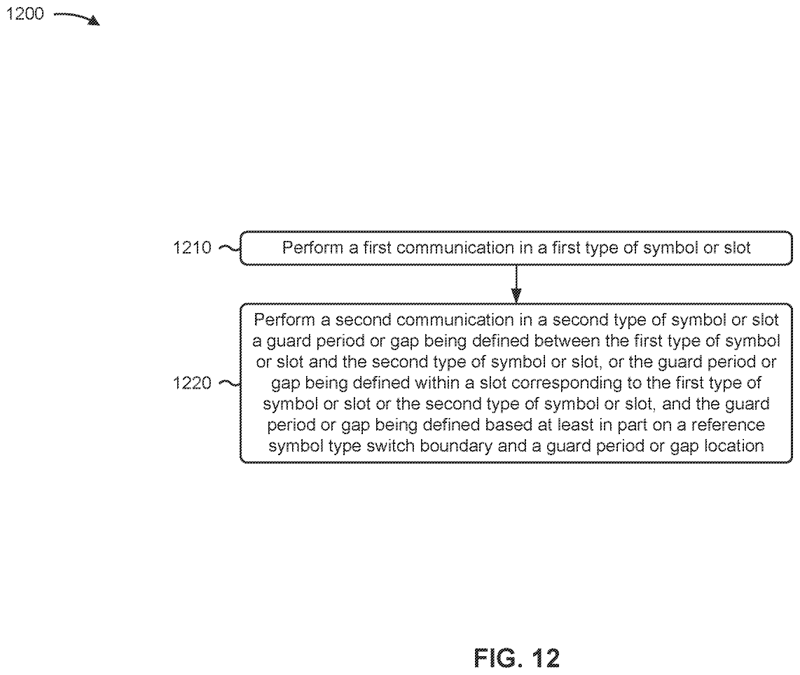

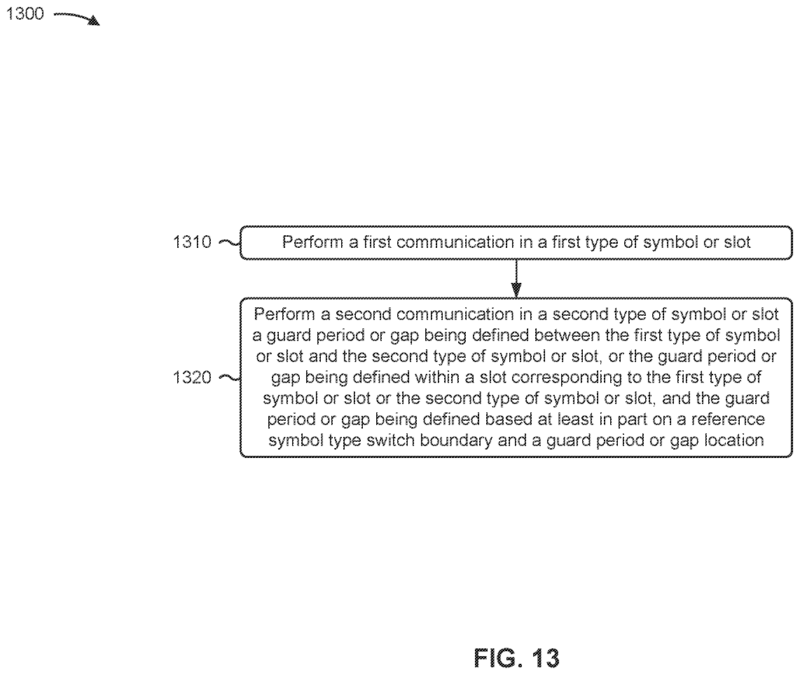

The controller/processor 240 of the network node 110, the controller/processor 280 of the UE 120, and/or any other component(s) of FIG. 2 may perform one or more techniques associated with guard periods or gaps between symbols/slots or within a slot, as described in more detail elsewhere herein. For example, the controller/processor 240 of the network node 110, the controller/processor 280 of the UE 120, and/or any other component(s) of FIG. 2 may perform or direct operations of, for example, process 1200 of FIG. 12, process 1300 of FIG. 13, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1200 of FIG. 12, process 1300 of FIG. 13, and/or other processes as described herein. In some examples, executing instructions may include running the instructions, converting the instructions, compiling the instructions, and/or interpreting the instructions, among other examples.

In some aspects, a UE (e.g., the UE 120) includes means for performing a first communication in a first type of symbol/slot; and/or means for performing a second communication in a second type of symbol/slot, a guard period/gap being defined between the first type of symbol/slot and the second type of symbol/slot, or the guard period/gap being defined within a slot corresponding to the first type of symbol/slot or the second type of symbol/slot, and the guard period/gap being defined based at least in part on a reference symbol type switch boundary and a guard period/gap location. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., the network node 110) includes means for performing a first communication in a first type of symbol/slot; and/or means for performing a second communication in a second type of symbol/slot, a guard period/gap being defined between the first type of symbol/slot and the second type of symbol/slot, or the guard period/gap being defined within a slot corresponding to the first type of symbol/slot or the second type of symbol/slot, and the guard period/gap being defined based at least in part on a reference symbol type switch boundary and a guard period/gap location. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (CNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

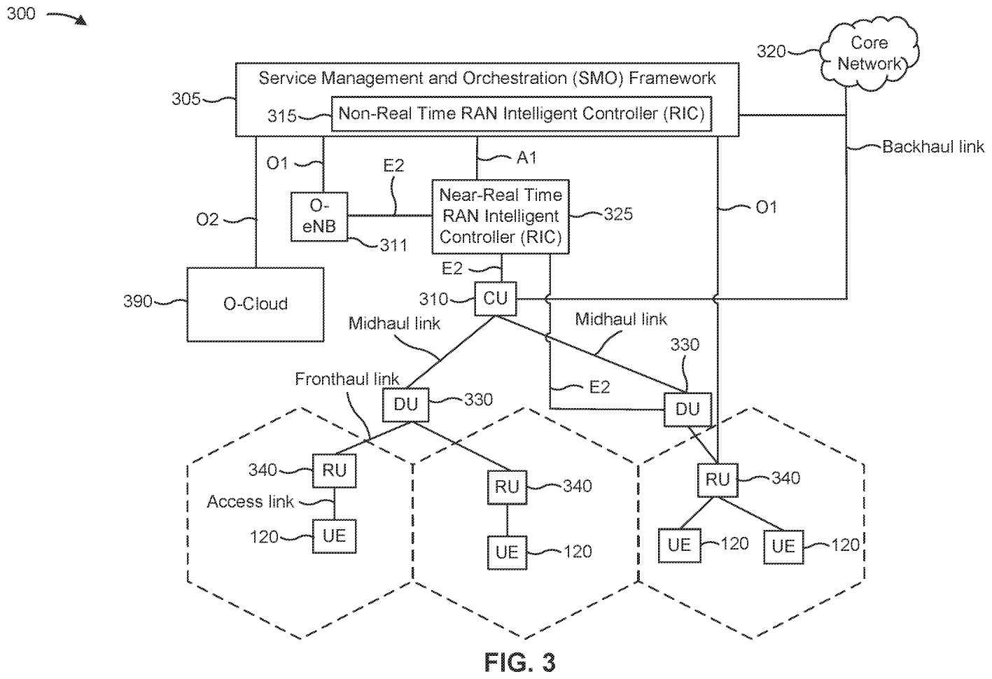

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective RF access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open cNB (O-cNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

A full duplex operation may involve an in-band full duplex (IBFD) operation, in which a transmission and a reception may occur on the same time and frequency resource. A downlink direction and an uplink direction may share the same IBFD time/frequency resource based at least in part on a full or partial overlap. Alternatively, the full duplex operation may involve an SBFD operation (or flexible duplex), in which a transmission and a reception may occur at the same time but on different frequency resources. A downlink resource may be separated from an uplink resource in a frequency domain. In the SBFD operation, no downlink and uplink overlap in frequency may occur.

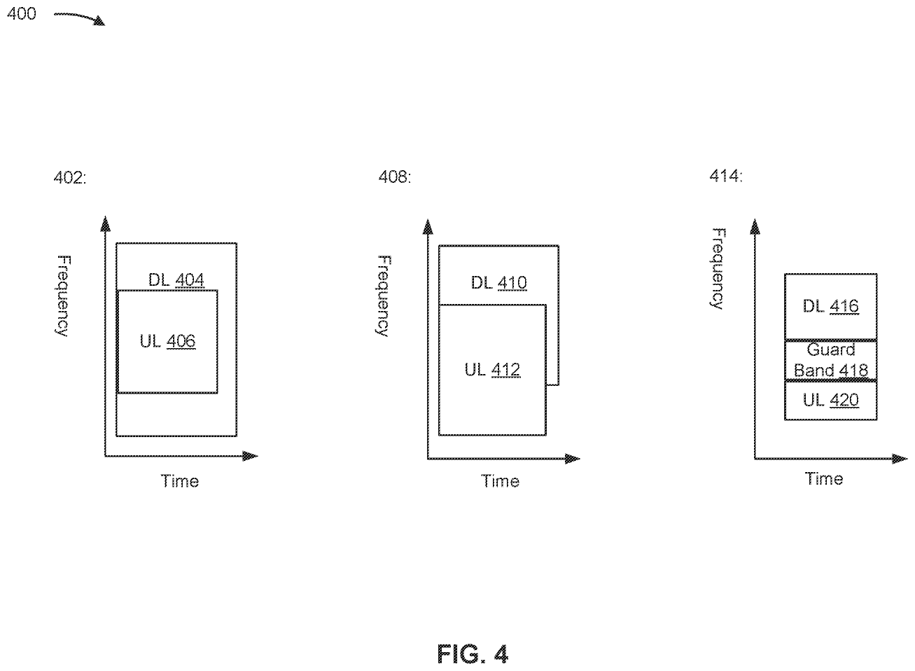

FIG. 4 is a diagram illustrating examples 400 of full duplex communications, in accordance with the present disclosure.

As shown by reference number 402, a downlink resource 404 and an uplink resource 406 may share the same IBFD time/frequency resource based at least in part on a full overlap. As shown by reference number 408, a downlink resource 410 and an uplink resource 412 may share the same IBFD time/frequency resource based at least in part on a partial overlap. As shown by reference number 414, a downlink resource 416 and an uplink resource 420 may be associated with a same time but different frequencies. The downlink resource 416 and the uplink resource 420 may be separated by a guard band 418.

As indicated above, FIG. 4 is provided as an example. Other examples may differ from what is described with regard to FIG. 4.

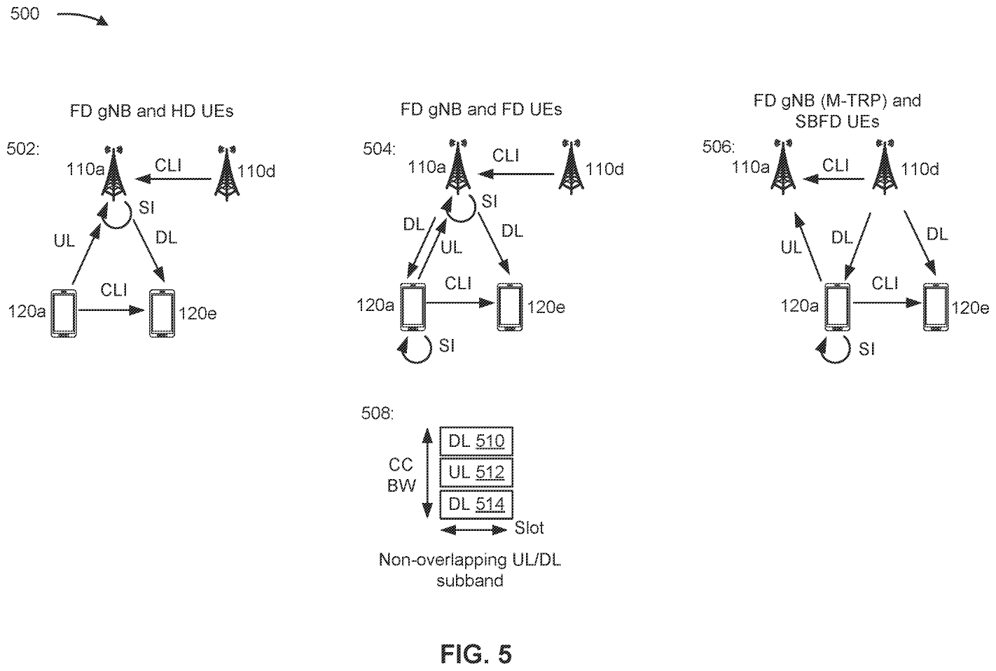

FIG. 5 is a diagram illustrating examples 500 of full duplex communications, in accordance with the present disclosure.

As shown by reference number 502, a full duplex network node (e.g., network node 110a) may communicate with half duplex UEs. The full duplex network node may be subjected to cross-link interference from another full duplex network node (e.g., network node 110d). The cross-link interference from the other full duplex network node may be inter-network-node cross-link interference. The full duplex network node may experience self-interference. The full duplex network node may receive an uplink transmission from a first half duplex UE (e.g., UE 120a), and the full duplex network node may transmit a downlink transmission to a second half duplex UE (e.g., UE 120c). The full duplex network node may receive the uplink transmission and transmit the downlink transmission on the same slot (e.g., a simultaneous reception/transmission). The second half duplex UE may be subjected to cross-link interference from the first half duplex UE (e.g., inter-UE cross-link interference).

As shown by reference number 504, a full duplex network node (e.g., network node 110a) may communicate with full duplex UEs. The full duplex network node may be subjected to cross-link interference from another full duplex network node (e.g., network node 110d). The full duplex network node may experience self-interference. The full duplex network node may transmit a downlink transmission to a first full duplex UE (e.g., UE 120a), and the full duplex network node may receive an uplink transmission from the first full duplex UE at the same time as the downlink transmission. The full duplex network node may transmit a downlink transmission to a second full duplex UE (e.g., UE 120c). The second half duplex UE may be subjected to cross-link interference from the first half duplex UE. The first UE may experience self-interference.

As shown by reference number 506, a first full duplex network node (e.g., network node 110a), which may be associated with multiple TRPs, may communicate with SBFD UEs. The first full duplex network node may be subjected to cross-link interference from a second full duplex network node (e.g., network node 110s). The first full duplex network node may receive an uplink transmission from a first SBFD UE (e.g., UE 120a). The second full duplex network node may transmit downlink transmissions to both the first SBFD UE and a second SBFD UE (e.g., UE 120c). The second SBFD UE may be subjected to cross-link interference from the first SBFD UE. The first SBFD UE may experience self-interference.

As shown by reference number 508, an SBFD slot may be associated with a non-overlapping uplink/downlink subband. The SBFD slot may be associated with a simultaneous transmission/reception of a downlink/uplink on a subband basis. Within a component carrier bandwidth, an uplink resource 512 may be between, in a frequency domain, a first downlink resource 510 and a second downlink resource 514. The first downlink resource 510, the second downlink resource 514, and the uplink resource 512 may all be associated with the same time.

An SBFD operation may be associated with a time division duplexing (TDD) or an intra-band carrier aggregation (CA). The SBFD operation may increase an uplink duty cycle, which may result in a latency reduction (e.g., an uplink signal may be transmitted in downlink-only slots, or a downlink signal may be received in uplink-only slots, which may enable latency savings) and uplink coverage improvement. The SBFD operation may improve a system capacity, resource utilization, and/or spectrum efficiency. The SBFD operation may enable a flexible and dynamic uplink/downlink resource adaption according to uplink/downlink traffic in a robust manner.

As indicated above, FIG. 5 is provided as an example. Other examples may differ from what is described with regard to FIG. 5.

An SBFD capable network node may configure resources with co-existing SBFD symbols/slots and non-SBFD/legacy downlink, uplink or flexible symbols/slots. When switching between the SBFD symbols/slots and the non-SBFD/legacy downlink, uplink or flexible symbols/slots, the network node and/or a UE may need a guard period/gap in between the SBFD symbols/slots and the non-SBFD/legacy downlink, uplink or flexible symbols/slots. The guard period/gap may allow the network node and/or the UE to retune certain RF/baseband blocks or filters. The guard period/gap may enable an adjusted uplink UE TA for aligning a network node downlink and uplink timing with a TA offset (e.g., TA offset 0) for an SBFD slot (e.g., an adjusted uplink UE TA for inter-UE CLI mitigation for the SBFD slot). The guard period/gap may enable the UE to perform a downlink-to-uplink direction switch, which may allow the UE to switch an RF given that an uplink timing is advanced to a downlink direction. The guard period/gap may ensure that inter-cell interference at the network node from other cells (in the downlink direction) may be avoided before an uplink direction of the network node. The guard period/gap may allow for the network node to adapt different antenna configurations, such as antenna elements or TXRUs for SBFD symbols/slots and non-SBFD/legacy downlink, uplink or flexible symbols/slots.

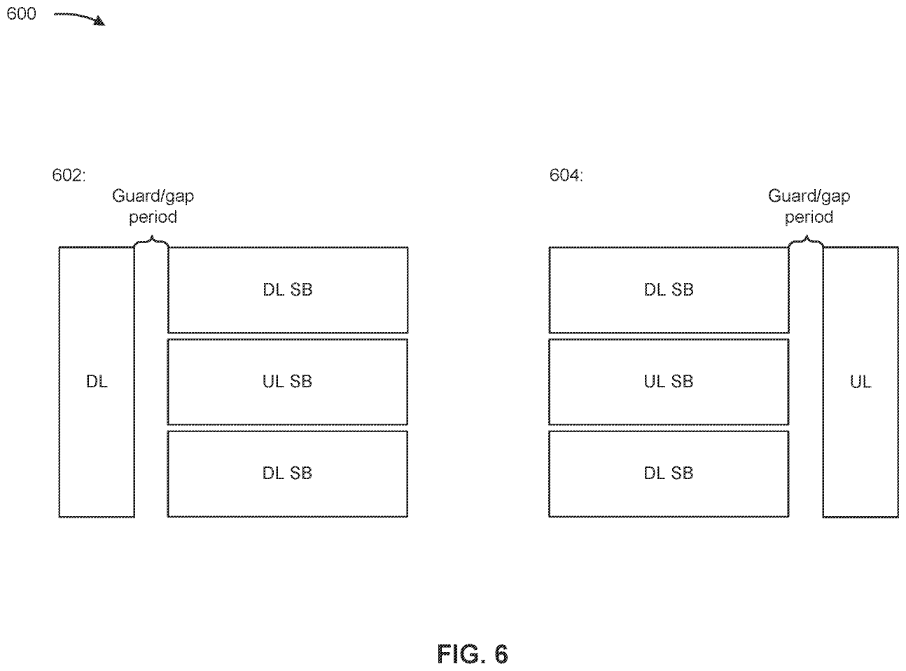

FIG. 6 is a diagram illustrating an example 600 of a guard period/gap between symbols/slots, in accordance with the present disclosure.

As shown by reference number 602, a first slot/symbol may be a downlink slot/symbol. A second slot/symbol may be an SBFD slot/symbol. The second slot/symbol may be associated with a first downlink subband. The second slot/symbol may be associated with an uplink subband. The second slot/symbol may be associated with a second downlink subband. The first slot/symbol and the second slot/symbol may need to be separated by a guard period/gap, which may provide time for performing an RF retuning, adjusting a TA, performing a downlink-to-uplink direction switch, or adapting a different antenna configuration.

As shown by reference number 604, a first slot/symbol may be an SBFD slot/symbol. The first slot/symbol may be associated with a first downlink subband. The first slot/symbol may be associated with an uplink subband. The first slot/symbol may be associated with a second downlink subband. A second slot/symbol may be an uplink slot/symbol. The first slot/symbol and the second slot/symbol may need to be separated by a guard period/gap, which may provide time for performing an RF retuning, adjusting a TA, performing a downlink-to-uplink direction switch, or adapting a different antenna configuration.

As indicated above, FIG. 6 is provided as an example. Other examples may differ from what is described with regard to FIG. 6.

In some cases, a UE and/or a network node may not be configured for a guard period/gap between symbols/slots. For example, the UE and/or the network node may not be configured for the guard period/gap between SBFD symbols/slots and non-SBFD/legacy downlink, uplink or flexible symbols/slots. The UE and/or the network node may not be configured with an allowed type switch boundary and a guard gap/period location rule. As a result, the UE and/or the network node may be unable to perform an RF retuning, adjust a TA, perform a downlink-to-uplink direction switch, and/or adapt a different antenna configuration between different symbols/slots, which may degrade a performance of the UE and/or the network node.

In various aspects of techniques and apparatuses described herein, a UE or a network node may perform a first communication in a first type of symbol/slot. The UE or the network node may perform a second communication in a second type of symbol/slot. The first type of symbol/slot may be an SBFD symbol/slot, and the second type of symbol/slot may be a non-SBFD downlink, uplink, or flexible symbol/slot. Alternatively, the first type of symbol/slot may be the non-SBFD downlink, uplink, or flexible symbol/slot, and the second type of symbol/slot may be the SBFD symbol/slot. A guard period/gap may be defined between the first type of symbol/slot and the second type of symbol/slot, or the guard period/gap may be defined within a slot corresponding to the first type of symbol/slot or the second type of symbol/slot. The guard period/gap may be defined based at least in part on a reference symbol type switch boundary and a guard period or gap location. In other words, the guard period/gap may be defined based at least in part on an allowed type switch boundary and a guard gap/period location rule. As a result, the UE and/or the network node may use the guard period/gap to perform an RF retuning, adjust a TA, perform a downlink-to-uplink direction switch, and/or adapt a different antenna configuration between different symbols/slots, which may improve a performance of the UE and/or the network node.

FIG. 7 is a diagram illustrating an example 700 associated with guard periods or gaps between symbols/slots or within a slot. As shown in FIG. 7, example 700 includes communication between a UE (e.g., UE 120) and a network node (e.g., network node 110). In some aspects, the UE and the network node may be included in a wireless network, such as wireless network 100.

As shown by reference number 702, the UE and/or the network node may perform a first communication in a first type of symbol/slot. The first type of symbol/slot may be an SBFD symbol/slot. Alternatively, the first type of symbol/slot may be a non-SBFD downlink, uplink, or flexible symbol/slot. The first communication may be a downlink transmission or an uplink transmission.

As shown by reference number 704, the UE and/or the network node may perform a second communication in a second type of symbol/slot. The second type of symbol/slot may be the non-SBFD downlink, uplink, or flexible symbol/slot. Alternatively, the first type of symbol/slot may be the SBFD symbol/slot. The second communication may be a downlink transmission or an uplink transmission. The second communication may be the same type as the first communication, or alternatively, the second communication may be a different type than the first communication. The first type of symbol/slot and the second first type of symbol/slot may form two types of symbols/slots, and one downlink or uplink occasion may be on the two types of symbols/slots, or two different downlink or uplink occasions may be on the two types of symbols/slots.

In some aspects, a guard period/gap may be defined between the first type of symbol/slot and the second type of symbol/slot, or the guard period/gap may be defined within a slot corresponding to the first type of symbol/slot or the second type of symbol/slot. The guard period/gap may be defined based at least in part on a reference symbol type switch boundary and a guard period or gap location.

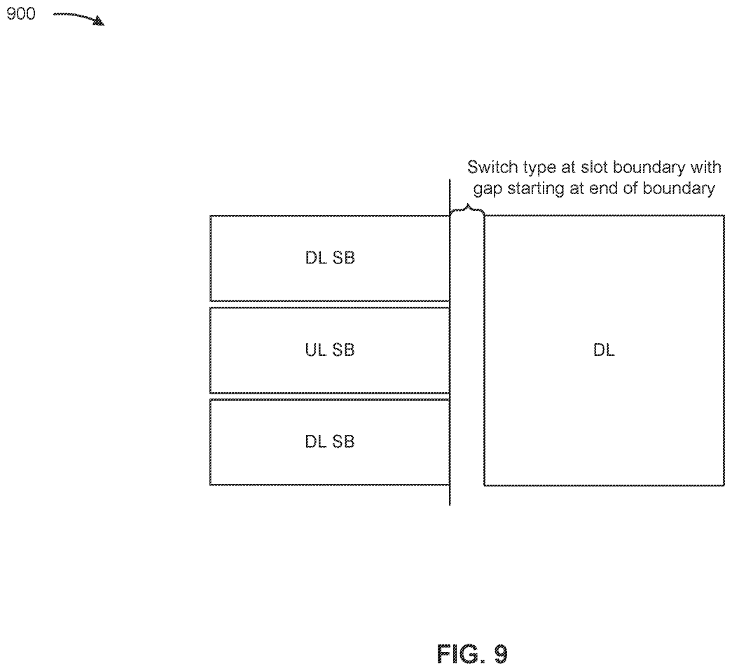

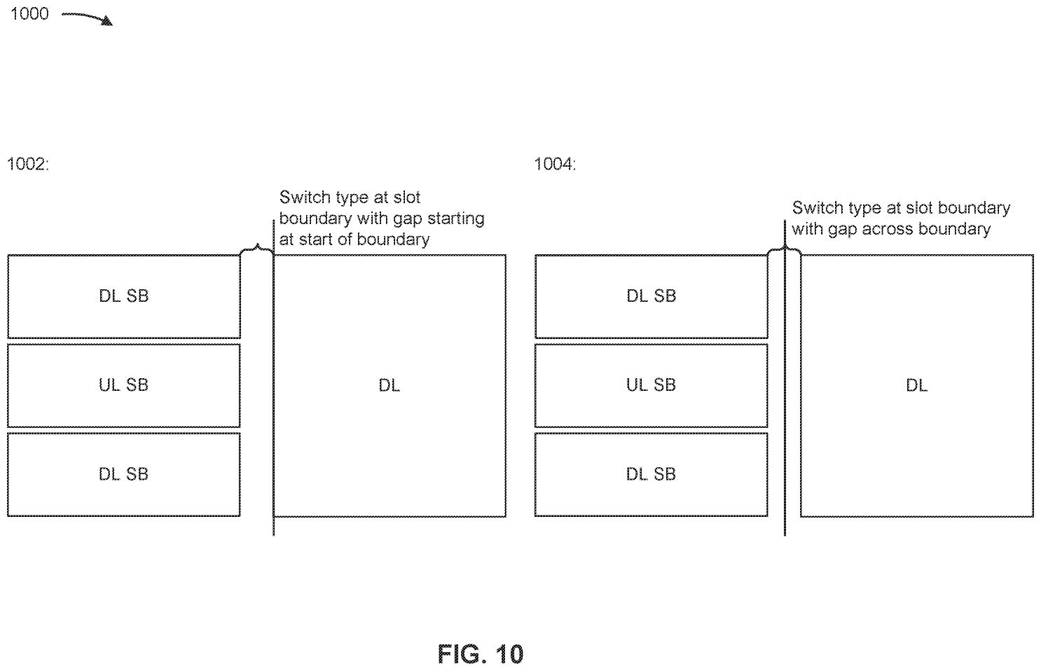

In some aspects, the reference symbol type switch boundary may correspond to a slot boundary of the first type of symbol/slot, or the second type of symbol/slot, based at least in part on an implicit rule for the guard period/gap. The guard period/gap location may define that the guard period/gap starts at an end of the reference symbol type switch boundary (e.g., as shown in FIG. 9). The guard period/gap location may define that the guard period/gap ends at a start of the reference symbol type switch boundary (e.g., as shown in FIG. 10). The guard period/gap location may define that the guard period/gap is across the reference symbol type switch boundary (e.g., as shown in FIG. 10). The guard period/gap location may define that the guard period/gap is within an SBFD slot or in a non-SBFD slot.

In some aspects, the guard period/gap location may define that the guard period/gap starts at an end of the reference symbol type switch boundary, or that the guard period/gap ends at a start of the reference symbol type switch boundary, depending on a symbol type combination. The guard period/gap location may define that the guard period/gap starts from the end of the reference symbol type switch boundary, based at least in part on the symbol type combination corresponding to an SBFD symbol followed by a non-SBFD symbol. The guard period/gap location may define that the guard period/gap ends at the start of the reference symbol type switch boundary, based at least in part on the symbol type combination corresponding to a non-SBFD symbol followed by an SBFD symbol.

In some aspects, a gap duration associated with the guard period/gap may be predefined in a specification, or may be indicated by the network node based at least in part on a UE capability, based at least in part on the reference symbol type switch boundary corresponding to the slot boundary. In some aspects, the guard period/gap may be associated with a UE common time pattern or a UE dedicated time pattern. The guard period/gap may be defined in terms of a quantity of symbols/slots or a quantity of milliseconds depending on a subcarrier spacing (SCS), based at least in part on the reference symbol type switch boundary corresponding to the slot boundary.

In some aspects, the reference symbol type switch boundary may correspond to the slot boundary of the first type of symbol/slot, or a slot boundary of the second type of symbol/slot, based at least in part on explicit signaling from the network node. The explicit signaling may indicate a periodic SBFD time pattern or a semi-persistent SBFD time pattern. The periodic SBFD time pattern or the semi-persistent SBFD time pattern may indicate whether a symbol/slot is a gap symbol/slot. The explicit signaling may indicate the guard period/gap location in an aperiodic pattern. The explicit signaling may indicate a guard period/gap starting symbol location, a guard period/gap length, a time window starting symbol location, and/or a bitmap for symbols in a time window for the guard period/gap.

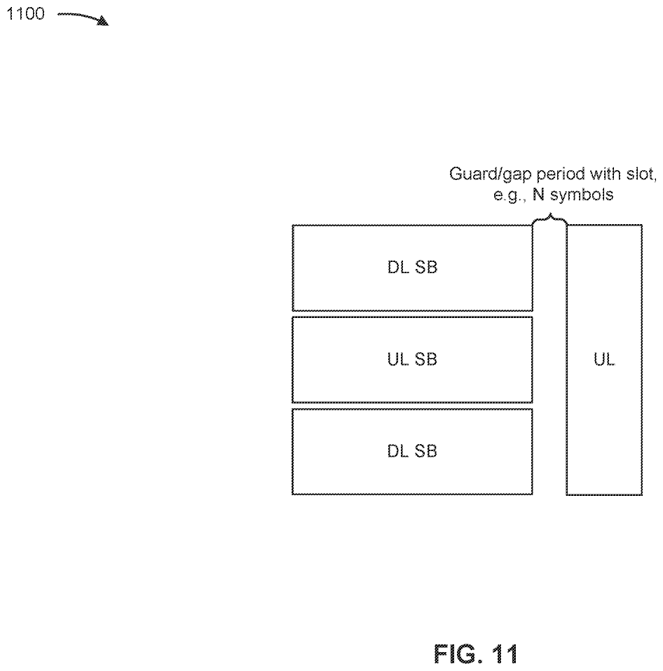

In some aspects, the reference symbol type switch boundary may be within the slot. The guard period/gap may be in terms of a quantity of symbols less than a slot duration (e.g., as shown in FIG. 11). A guard period/gap start time and a guard period/gap end time may be in any symbol boundary within the slot. The guard period/gap may be in terms of a quantity of slots larger than a slot duration. The guard period/gap start time and a guard period/gap end time may correspond to the slot boundary.

In some aspects, the reference symbol type switch boundary may be within the slot, based at least in part on an implicit rule for the guard period/gap. The guard period/gap location may define that the guard period/gap starts from a first slot after an end of the reference symbol type switch boundary. The guard period/gap location may define that the guard period/gap ends at an end of a last slot before a start of the reference symbol type switch boundary. The guard period/gap location may define that the guard period/gap starts from the first slot after the end of the reference symbol type switch boundary, or that the guard period/gap ends at the end of the last slot before the start of the reference symbol type switch boundary, depending on a symbol type combination.

In some aspects, a gap duration associated with the guard period/gap may be predefined in a specification, or may be indicated by the network node based at least in part on a UE capability, based at least in part on the reference symbol type switch boundary being within the slot. The guard period/gap may be associated with a UE common time pattern or a UE dedicated time pattern. The guard period/gap may be defined in terms of a quantity of symbols/slots or a quantity of milliseconds depending on an SCS, based at least in part on the reference symbol type switch boundary being within the slot.

In some aspects, the reference symbol type switch boundary may be within the slot, based at least in part on explicit signaling from the network node. The explicit signaling may indicate a slot format indicator (SFI) or a TDD slot format pattern having a slot format as a gap slot, and may indicate a corresponding slot format index per slot in a period of slots. The explicit signaling may indicate the guard period/gap location in an aperiodic pattern. The explicit signaling may indicate a guard period/gap starting symbol location, a guard period/gap length, a time window starting symbol location, and/or a bitmap for symbols in a time window for the guard period/gap.

In some aspects, the guard period/gap may be defined in a specification, indicated by the network node, or requested by the UE. The guard period/gap may be a quantity of symbols or slots, or a quantity of microseconds or milliseconds. The guard period/gap may be a common value or is associated with different values, depending on a switching of two types of symbols or slots and a transmit-receive direction. The UE may be an SBFD-aware UE and may not be expected to perform communications in the guard period/gap.

As indicated above, FIG. 7 is provided as an example. Other examples may differ from what is described with regard to FIG. 7.

In some aspects, no guard gap/period may be defined between SBFD symbols/slots (or mini-slots) and non-SBFD/legacy downlink, uplink or flexible symbols/slots. In this case, an allowed SBFD symbols/slots type and a non-SBFD/legacy downlink, uplink or flexible symbols/slots type switch boundary may be, in a first option, an allowed type switch boundary only at a slot boundary, or in a second option, an allowed type switch boundary within a slot. In other words, a switch boundary may be at the slot boundary or within the slot.

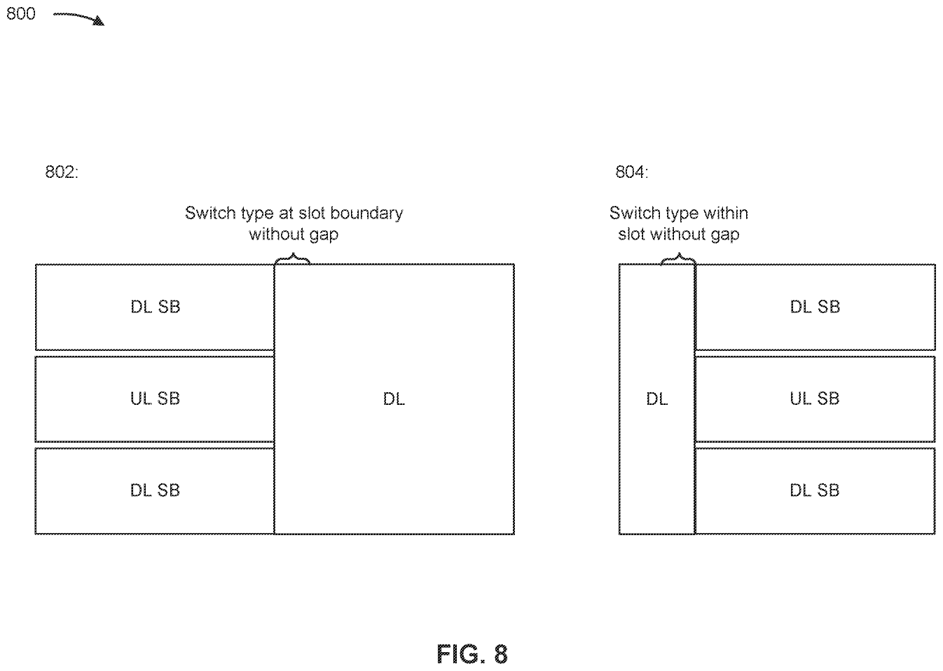

FIG. 8 is a diagram illustrating an example 800 associated with guard periods or gaps between symbols/slots or within a slot.

As shown by reference number 802, a first slot may be an SBFD slot. The first slot may be associated with a first downlink subband, an uplink subband, and a second downlink subband. A second slot may be a downlink slot. An allowed type switch boundary may be at a slot boundary (e.g., only at the slot boundary) with respect to the first slot and the second slot. For example, the allowed type switch boundary may occur at a boundary associated with the second slot. In this example, no guard gap/period may occur between the first slot and the second slot.

As shown by reference number 804, a slot may include non-SBFD/legacy downlink symbols. The slot may also include SBFD symbols, which may be associated with a first downlink subband, an uplink subband, and a second downlink subband. An allowed type switch boundary may be within the slot. For example, the allowed type switch boundary may occur within the non-SBFD/legacy downlink symbols. In this example, no guard gap/period may occur within the slot.

As indicated above, FIG. 8 is provided as an example. Other examples may differ from what is described with regard to FIG. 8.

In some aspects, a guard gap/period may be defined between SBFD symbols/slots and non-SBFD/legacy downlink, uplink or flexible symbols/slots. Continuous symbols per symbol type (e.g., continuous uplink/downlink symbols associated with an SBFD slot) may be larger than the guard gap/period (e.g., at least X % larger), which may reduce a symbol type switching overhead. In some aspects, a reference symbol type switch boundary may be defined at a slot boundary (e.g., only at the slot boundary). At each side of the reference symbol type switch boundary, a symbol type may be different.

In some aspects, when the guard gap/period is defined between SBFD symbols/slots and non-SBFD/legacy downlink, uplink or flexible symbols/slots, the guard gap/period may be based at least in part on an implicit rule (e.g., a guard period/gap location rule that is implicit). The guard period/gap location rule may define that the guard gap/period starts at an end of the reference symbol type switch boundary.

In some aspects, a flexible symbol or flexible symbols may be used in a special slot to indicate the guard gap/period. The flexible symbol may be for the guard gap/period, but may not be for a downlink-to-uplink switch.

FIG. 9 is a diagram illustrating an example 900 associated with guard periods or gaps between symbols/slots or within a slot.

As shown by FIG. 9, a first slot may be an SBFD slot. The first slot may be associated with a first downlink subband, an uplink subband, and a second downlink subband. A second slot may be a downlink slot. An allowed type switch boundary may be a switch type at a slot boundary with a guard gap/period starting at an end of the slot boundary. The slot boundary may correspond to an end of the first slot. As an example, the guard gap/period may be three symbols. The guard gap/period may be defined based at least in part on the slot boundary.

As indicated above, FIG. 9 is provided as an example. Other examples may differ from what is described with regard to FIG. 9.

In some aspects, a guard period/gap location rule may define that a guard gap/period starts at an end of a reference symbol type switch boundary. The guard period/gap location rule may define that the guard gap/period ends from a start of the reference symbol type switch boundary. The guard period/gap location rule may define that the guard gap/period is across the reference symbol type switch boundary (e.g., end of a high quantity of all gap symbols). The guard period/gap location rule may define that the guard gap/period is on an SBFD slot or a non-SBFD slot.

FIG. 10 is a diagram illustrating an example 1000 associated with guard periods or gaps between symbols/slots or within a slot.

As shown by reference number 1002, a first slot may be an SBFD slot. The first slot may be associated with a first downlink subband, an uplink subband, and a second downlink subband. A second slot may be a downlink slot. An allowed type switch boundary may be a switch type at a slot boundary with a guard gap/period ending from a start of the slot boundary. The slot boundary may correspond to a start of the second slot. As an example, the guard gap/period may be three symbols.

As shown by reference number 1004, a first slot may be an SBFD slot. The first slot may be associated with a first downlink subband, an uplink subband, and a second downlink subband. A second slot may be a downlink slot. An allowed type switch boundary may be a switch type at a slot boundary with a guard gap/period ending across the slot boundary. The slot boundary may be in between the first slot and the second slot, such that the slot boundary may occur one or two symbols after an end of the first slot and one or two symbols before a start of the second slot.

As indicated above, FIG. 10 is provided as an example. Other examples may differ from what is described with regard to FIG. 10.

In some aspects, whether a guard gap/period starts at an end of a reference symbol type switch boundary or whether the guard gap/period ends from a start of the reference symbol type switch boundary may depend on a symbol type combination. When the symbol type combination is an SBFD symbol and a non-SBFD symbol, the guard gap/period may start from the end of the reference symbol type switch boundary. When the symbol type combination is a non-SBFD symbol and an SBFD symbol, the guard gap/period may end from the start of the reference symbol type switch boundary. Non-SBFD symbols may be utilized for the guard gap/period in order to prioritize SBFD symbols, or alternatively, SBFD symbols may be utilized for the guard gap/period in order to prioritize non-SBFD symbols.

In some aspects, when the reference symbol type switch boundary is defined at a slot boundary, a gap duration associated with the guard gap/period may be predefined in a specification, and/or may be indicated by a network node to a UE based at least in part on a UE capability. The gap duration may be for a UE common gap pattern and/or a UE dedicated gap pattern. The guard gap/period may be defined in terms of symbols/slots, which may be SCS dependent. The gap duration may depend on a combination of symbol types.

In some aspects, when the reference symbol type switch boundary is defined at a slot boundary, the guard gap/period may be based at least in part on explicit signaling from the network node to the UE. The explicit signaling may indicate which symbol is a gap symbol. In some aspects, a periodic SBFD pattern or a semi-persistent SBFD pattern may indicate whether a symbol is a gap symbol in addition to existing symbol types. For example, for two bits, “00” may indicate a legacy TDD pattern, “01” may indicate SBFD, and “10” may indicate a guard period/gap per symbol or per slot. The periodic SBFD pattern or the semi-persistent SBFD pattern may be indicated via RRC signaling or via a MAC control element (MAC-CE). In some aspects, the guard period/gap location may be indicated in an aperiodic pattern. One guard period/gap occasion or multiple guard period/gap occasions may occur in a time window, but may not repeat after the time window. As an example, for one guard period/gap, a gap starting symbol location and a gap length may be indicated by the network node. As another example, for multiple guard periods/gaps in the time window, a window starting symbol location and a bitmap for symbols in the time window for the guard periods/gaps (e.g., whether a symbol is a guard period/gap symbol) may be indicated by the network node.

In some aspects, the reference symbol type switch boundary may be within a slot. The guard period/gap may be in terms of symbols. For example, a guard period/gap start/end time may be any symbol boundary. In this case, the guard period/gap start/end time may not be associated with the slot boundary (e.g., any symbol within the slot may correspond to the guard period/gap start/end time).

FIG. 11 is a diagram illustrating an example 1100 associated with guard periods or gaps between symbols/slots or within a slot.

As shown by FIG. 11, a slot may include SBFD symbols, which may be associated with a first downlink subband, an uplink subband, and a second downlink subband. The slot may also be associated with non-SBFD/legacy uplink symbols. A guard gap/period may occur within the slot. For example, the guard gap/period may span N symbols within the slot.

As indicated above, FIG. 11 is provided as an example. Other examples may differ from what is described with regard to FIG. 11.

In some aspects, a reference symbol type switch boundary may be within a slot. A guard period/gap may be in terms of slots. Slots may be associated with a relatively high SCS frequency band, such as an SCS of 480 kHz or 960 kHz. Slots may be associated with a relatively small slot duration. A guard period/gap start/end time may be within a slot boundary.

In some aspects, the guard period/gap may be based at least in part on an implicit rule (e.g., a guard period/gap location rule that is implicit). The guard period/gap may start from a first slot after an end of the reference symbol type switch boundary, and remaining symbols before the guard period/gap may be dropped. The guard period/gap may start at an end of a last slot before a start of the reference symbol type switch boundary, and remaining symbols before the guard period/gap may be dropped. Whether the guard period/gap starts from the first slot after the end of the reference symbol type switch boundary or whether the guard period/gap starts from the end of the last slot before the start of the reference symbol type switch boundary may depend on a symbol type combination. When the symbol type combination is an SBFD symbol and a non-SBFD symbol, the guard period/gap may start from the first slot after the end of the reference symbol type switch boundary. When the symbol type combination is a non-SBFD symbol and an SBFD symbol, the guard period/gap may start from the end of the last slot before the start of the reference symbol type switch boundary. Non-SBFD symbols may be utilized for the guard gap/period in order to prioritize SBFD symbols, or alternatively, SBFD symbols may be utilized for the guard gap/period in order to prioritize non-SBFD symbols.

In some aspects, when the reference symbol type switch boundary is within the slot, a gap duration associated with the guard gap/period may be predefined in a specification, and/or may be indicated by a network node to a UE based at least in part on a UE capability. The gap duration may be for a UE common gap pattern and/or a UE dedicated gap pattern. The guard gap/period may be defined in terms of symbols/slots, which may be SCS dependent. The gap duration may depend on a combination of symbol types.

In some aspects, when the reference symbol type switch boundary is within the slot, the guard gap/period may be based at least in part on explicit signaling from the network node to the UE. In some aspects, in an SFI or a TDD pattern, a slot format may be added as a gap slot, and a corresponding slot format index per slot in a period of slots may be indicated by the network node. For example, a reserved slot format identifier may be used for a gap slot identifier. As another example, for 100 slots per period in the TDD pattern, the network node may indicate the slot format identifier per slot in a period for the guard gap/period. In some cases, a gap slot pattern may be a dedicated pattern and not combined with the TDD pattern (e.g., “1” or “0’ for each slot in a period of slots). A periodic slot pattern or a semi-persistent slot pattern may be indicated via RRC signaling or a MAC-CE. In some aspects, a guard period/gap location may be indicated in an aperiodic pattern. One guard period/gap occasion or multiple guard period/gap occasions may occur in a time window, but may not repeat after the time window. As an example, for one guard period/gap, a gap starting symbol location and a gap length may be indicated by the network node. As another example, for multiple guard periods/gaps in the time window, a window starting symbol location and a bitmap for symbols in the time window for the guard periods/gaps (e.g., whether a symbol is a guard period/gap symbol) may be indicated by the network node.

In some aspects, the guard gap/period may be defined in a specification, indicated by the network node, and/or requested by the UE (e.g., a conditional request when a UE requested gap period is larger than a network node configured cell common gap period). The guard gap/period may be N symbols/slots or K us/ms (mapped to N symbols/slots depending on an SCS). The guard gap/period may be common values or different values, depending on a switching from one type and one transmit/receive (Tx/Rx) direction to another type and a same/different Tx/Rx direction. In some cases, an SBFD aware UE may not expect to transmit or receive in the guard gap/period.

FIG. 12 is a diagram illustrating an example process 1200 performed, for example, by a UE, in accordance with the present disclosure. Example process 1200 is an example where the UE (e.g., UE 120) performs operations associated with guard periods/gaps between symbols/slots or within a slot.

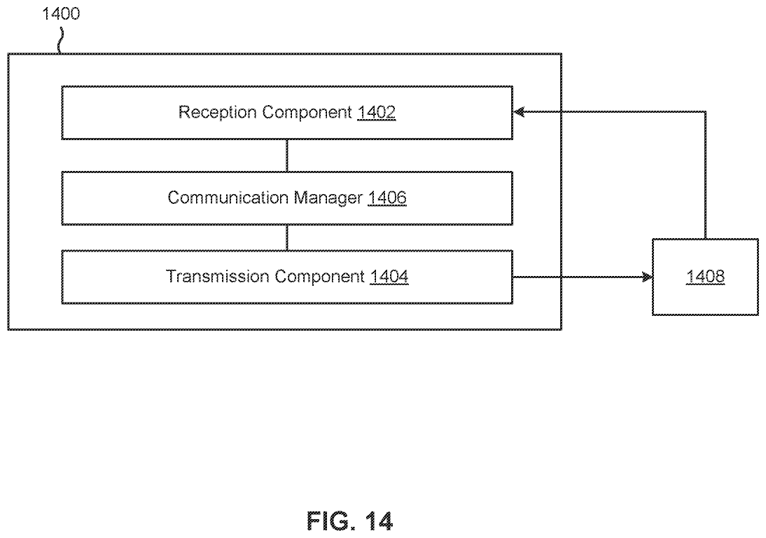

As shown in FIG. 12, in some aspects, process 1200 may include performing a first communication in a first type of symbol/slot (block 1210). For example, the UE (e.g., using communication manager 1406, depicted in FIG. 14) may perform a first communication in a first type of symbol/slot, as described above.

As further shown in FIG. 12, in some aspects, process 1200 may include performing a second communication in a second type of symbol/slot, a guard period/gap being defined between the first type of symbol/slot and the second type of symbol/slot, or the guard period/gap being defined within a slot corresponding to the first type of symbol/slot or the second type of symbol/slot, and the guard period/gap being defined based at least in part on a reference symbol type switch boundary and a guard period/gap location (block 1220). For example, the UE (e.g., using communication manager 1406, depicted in FIG. 14) may perform a second communication in a second type of symbol/slot, a guard period/gap being defined between the first type of symbol/slot and the second type of symbol/slot, or the guard period/gap being defined within a slot corresponding to the first type of symbol/slot or the second type of symbol/slot, and the guard period/gap being defined based at least in part on a reference symbol type switch boundary and a guard period/gap location, as described above.

Process 1200 may include additional aspects, such as any single aspect or any combination of aspects described below and/or in connection with one or more other processes described elsewhere herein.

In a first aspect, the first type of symbol/slot is an SBFD symbol/slot, and the second type of symbol/slot is a non-SBFD downlink, uplink, or flexible symbol/slot, or the first type of symbol/slot is the non-SBFD downlink, uplink, or flexible symbol/slot, and the second type of symbol/slot is the SBFD symbol/slot.

In a second aspect, alone or in combination with the first aspect, the reference symbol type switch boundary corresponds to a slot boundary of the first type of symbol/slot, or the second type of symbol/slot, based at least in part on an implicit rule for the guard period/gap.

In a third aspect, alone or in combination with one or more of the first and second aspects, the guard period/gap location defines that the guard period/gap starts at an end of the reference symbol type switch boundary.

In a fourth aspect, alone or in combination with one or more of the first through third aspects, the guard period/gap location defines that the guard period/gap ends at a start of the reference symbol type switch boundary.

In a fifth aspect, alone or in combination with one or more of the first through fourth aspects, the guard period/gap location defines that the guard period/gap is across the reference symbol type switch boundary.

In a sixth aspect, alone or in combination with one or more of the first through fifth aspects, the guard period/gap location defines that the guard period/gap is within an SBFD slot or in a non-SBFD slot.

In a seventh aspect, alone or in combination with one or more of the first through sixth aspects, the guard period/gap location defines that the guard period/gap starts at an end of the reference symbol type switch boundary, or that the guard period/gap ends at a start of the reference symbol type switch boundary, depending on a symbol type combination.

In an eighth aspect, alone or in combination with one or more of the first through seventh aspects, the guard period/gap location defines that the guard period/gap starts from the end of the reference symbol type switch boundary, based at least in part on the symbol type combination corresponding to an SBFD symbol followed by a non-SBFD symbol, or the guard period/gap location defines that the guard period/gap ends at the start of the reference symbol type switch boundary, based at least in part on the symbol type combination corresponding to a non-SBFD symbol followed by an SBFD symbol.

In a ninth aspect, alone or in combination with one or more of the first through eighth aspects, a gap duration associated with the guard period/gap is predefined in a specification, or is indicated by a network node based at least in part on a UE capability, based at least in part on the reference symbol type switch boundary corresponding to the slot boundary.

In a tenth aspect, alone or in combination with one or more of the first through ninth aspects, the guard period/gap is associated with a UE common time pattern or a UE dedicated time pattern, and the guard period/gap being defined in terms of a quantity of symbols or slots or a quantity of milliseconds depending on a subcarrier spacing, based at least in part on the reference symbol type switch boundary corresponding to the slot boundary.

In an eleventh aspect, alone or in combination with one or more of the first through tenth aspects, the reference symbol type switch boundary corresponds to a slot boundary of the first type of symbol/slot, or a slot boundary of the second type of symbol/slot, based at least in part on explicit signaling from a network node.

In a twelfth aspect, alone or in combination with one or more of the first through eleventh aspects, the explicit signaling indicates a periodic SBFD time pattern or a semi-persistent SBFD time pattern, the periodic SBFD time pattern or the semi-persistent SBFD time pattern indicating whether a symbol/slot is a gap symbol/slot.

In a thirteenth aspect, alone or in combination with one or more of the first through twelfth aspects, the explicit signaling indicates the guard period/gap location in an aperiodic pattern, the explicit signaling indicating one or more of a guard period/gap starting symbol location, a guard period/gap length, a time window starting symbol location, or a bitmap for symbols in a time window for the guard period/gap.

In a fourteenth aspect, alone or in combination with one or more of the first through thirteenth aspects, the reference symbol type switch boundary is within the slot.

In a fifteenth aspect, alone or in combination with one or more of the first through fourteenth aspects, the guard period/gap is in terms of a quantity of symbols less than a slot duration, a guard period/gap start time and a guard period/gap end time being in any symbol boundary within the slot.

In a sixteenth aspect, alone or in combination with one or more of the first through fifteenth aspects, the guard period/gap is in terms of a quantity of slots larger than a slot duration, a guard period/gap start time and a guard period/gap end time corresponding to a slot boundary.

In a seventeenth aspect, alone or in combination with one or more of the first through sixteenth aspects, the reference symbol type switch boundary is within the slot, based at least in part on an implicit rule for the guard period/gap.

In an eighteenth aspect, alone or in combination with one or more of the first through seventeenth aspects, the guard period/gap location defines that the guard period/gap starts from a first slot after an end of the reference symbol type switch boundary.

In a nineteenth aspect, alone or in combination with one or more of the first through eighteenth aspects, the guard period/gap location defines that the guard period/gap ends at an end of a last slot before a start of the reference symbol type switch boundary.

In a twentieth aspect, alone or in combination with one or more of the first through nineteenth aspects, the guard period/gap location defines that the guard period/gap starts from a first slot after an end of the reference symbol type switch boundary, or that the guard period/gap ends at an end of a last slot before a start of the reference symbol type switch boundary, depending on a symbol type combination.

In a twenty-first aspect, alone or in combination with one or more of the first through twentieth aspects, a gap duration associated with the guard period/gap is predefined in a specification, or is indicated by a network node based at least in part on a UE capability, based at least in part on the reference symbol type switch boundary being within the slot.

In a twenty-second aspect, alone or in combination with one or more of the first through twenty-first aspects, the guard period/gap is associated with a UE common time pattern or a UE dedicated time pattern, and the guard period/gap being defined in terms of a quantity of symbols or slots or a quantity of milliseconds depending on a subcarrier spacing, based at least in part on the reference symbol type switch boundary being within the slot.

In a twenty-third aspect, alone or in combination with one or more of the first through twenty-second aspects, the reference symbol type switch boundary is within the slot, based at least in part on explicit signaling from a network node.

In a twenty-fourth aspect, alone or in combination with one or more of the first through twenty-third aspects, the explicit signaling indicates an SFI or a TDD slot format pattern having a slot format as a gap slot, and indicating a corresponding slot format index per slot in a period of slots.

In a twenty-fifth aspect, alone or in combination with one or more of the first through twenty-fourth aspects, the explicit signaling indicates the guard period/gap location in an aperiodic pattern, the explicit signaling indicating one or more of a guard period/gap starting symbol location, a guard period/gap length, a time window starting symbol location, or a bitmap for symbols in a time window for the guard period/gap.

In a twenty-sixth aspect, alone or in combination with one or more of the first through twenty-fifth aspects, the guard period/gap is defined in a specification, indicated by a network node, or requested by the UE.

In a twenty-seventh aspect, alone or in combination with one or more of the first through twenty-sixth aspects, the guard period/gap is a quantity of symbols or slots, or a quantity of microseconds or milliseconds.

In a twenty-eighth aspect, alone or in combination with one or more of the first through twenty-seventh aspects, the guard period/gap is a common value or is associated with different values, depending on a switching of two types of symbols or slots and a transmit-receive direction.

In a twenty-ninth aspect, alone or in combination with one or more of the first through twenty-eighth aspects, the UE is an SBFD-aware UE and is not expected to perform communications in the guard period/gap.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, by a network node, in accordance with the present disclosure. Example process 1300 is an example where the network node (e.g., network node 110) performs operations associated with guard periods/gaps between symbols/slots or within a slot.

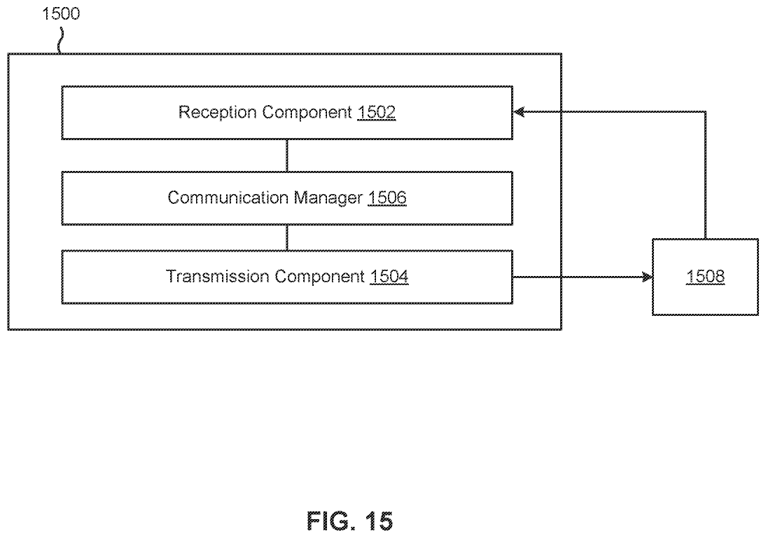

As shown in FIG. 13, in some aspects, process 1300 may include performing a first communication in a first type of symbol/slot (block 1310). For example, the network node (e.g., using communication manager 1506, depicted in FIG. 15) may perform a first communication in a first type of symbol/slot, as described above.

As further shown in FIG. 13, in some aspects, process 1300 may include performing a second communication in a second type of symbol/slot, a guard period/gap being defined between the first type of symbol/slot and the second type of symbol/slot, or the guard period/gap being defined within a slot corresponding to the first type of symbol/slot or the second type of symbol/slot, and the guard period/gap being defined based at least in part on a reference symbol type switch boundary and a guard period/gap location (block 1320). For example, the network node (e.g., using communication manager 1506, depicted in FIG. 15) may perform a second communication in a second type of symbol/slot, a guard period/gap being defined between the first type of symbol/slot and the second type of symbol/slot, or the guard period/gap being defined within a slot corresponding to the first type of symbol/slot or the second type of symbol/slot, and the guard period/gap being defined based at least in part on a reference symbol type switch boundary and a guard period/gap location, as described above.

Process 1300 may include additional aspects, such as any single aspect or any combination of aspects described below and/or in connection with one or more other processes described elsewhere herein.

In a first aspect, the first type of symbol/slot is an SBFD symbol/slot, and the second type of symbol/slot is a non-SBFD downlink, uplink, or flexible symbol/slot, or the first type of symbol/slot is the non-SBFD downlink, uplink, or flexible symbol/slot, and the second type of symbol/slot is the SBFD symbol/slot.

In a second aspect, alone or in combination with the first aspect, the reference symbol type switch boundary corresponds to a slot boundary of the first type of symbol/slot, or the second type of symbol/slot, based at least in part on an implicit rule for the guard period/gap.

In a third aspect, alone or in combination with one or more of the first and second aspects, the guard period/gap location defines that the guard period/gap starts at an end of the reference symbol type switch boundary.

In a fourth aspect, alone or in combination with one or more of the first through third aspects, the guard period/gap location defines that the guard period/gap ends at a start of the reference symbol type switch boundary.

In a fifth aspect, alone or in combination with one or more of the first through fourth aspects, the guard period/gap location defines that the guard period/gap is across the reference symbol type switch boundary.

In a sixth aspect, alone or in combination with one or more of the first through fifth aspects, the guard period/gap location defines that the guard period/gap is within an SBFD slot or in a non-SBFD slot.

In a seventh aspect, alone or in combination with one or more of the first through sixth aspects, the guard period/gap location defines that the guard period/gap starts at an end of the reference symbol type switch boundary, or that the guard period/gap ends at a start of the reference symbol type switch boundary, depending on a symbol type combination.

In an eighth aspect, alone or in combination with one or more of the first through seventh aspects, the guard period/gap location defines that the guard period/gap starts from the end of the reference symbol type switch boundary, based at least in part on the symbol type combination corresponding to an SBFD symbol followed by a non-SBFD symbol, or the guard period/gap location defines that the guard period/gap ends at the start of the reference symbol type switch boundary, based at least in part on the symbol type combination corresponding to a non-SBFD symbol followed by an SBFD symbol.

In a ninth aspect, alone or in combination with one or more of the first through eighth aspects, a gap duration associated with the guard period/gap is predefined in a specification, or is indicated by a network node based at least in part on a UE capability, based at least in part on the reference symbol type switch boundary corresponding to the slot boundary.

In a tenth aspect, alone or in combination with one or more of the first through ninth aspects, the guard period/gap is associated with a UE common time pattern or a UE dedicated time pattern, and the guard period/gap being defined in terms of a quantity of symbols or slots or a quantity of milliseconds depending on a subcarrier spacing, based at least in part on the reference symbol type switch boundary corresponding to the slot boundary.

In an eleventh aspect, alone or in combination with one or more of the first through tenth aspects, the reference symbol type switch boundary corresponds to a slot boundary of the first type of symbol/slot, or a slot boundary of the second type of symbol/slot, based at least in part on explicit signaling from a network node.

In a twelfth aspect, alone or in combination with one or more of the first through eleventh aspects, the explicit signaling indicates a periodic SBFD time pattern or a semi-persistent SBFD time pattern, the periodic SBFD time pattern or the semi-persistent SBFD time pattern indicating whether a symbol/slot is a gap symbol/slot.

In a thirteenth aspect, alone or in combination with one or more of the first through twelfth aspects, the explicit signaling indicates the guard period/gap location in an aperiodic pattern, the explicit signaling indicating one or more of a guard period/gap starting symbol location, a guard period/gap length, a time window starting symbol location, or a bitmap for symbols in a time window for the guard period/gap.

In a fourteenth aspect, alone or in combination with one or more of the first through thirteenth aspects, the reference symbol type switch boundary is within the slot.

In a fifteenth aspect, alone or in combination with one or more of the first through fourteenth aspects, the guard period/gap is in terms of a quantity of symbols less than a slot duration, a guard period/gap start time and a guard period/gap end time being in any symbol boundary within the slot.

In a sixteenth aspect, alone or in combination with one or more of the first through fifteenth aspects, the guard period/gap is in terms of a quantity of slots larger than a slot duration, a guard period/gap start time and a guard period/gap end time corresponding to a slot boundary.

In a seventeenth aspect, alone or in combination with one or more of the first through sixteenth aspects, the reference symbol type switch boundary is within the slot, based at least in part on an implicit rule for the guard period/gap.

In an eighteenth aspect, alone or in combination with one or more of the first through seventeenth aspects, the guard period/gap location defines that the guard period/gap starts from a first slot after an end of the reference symbol type switch boundary.

In a nineteenth aspect, alone or in combination with one or more of the first through eighteenth aspects, the guard period/gap location defines that the guard period/gap ends at an end of a last slot before a start of the reference symbol type switch boundary.

In a twentieth aspect, alone or in combination with one or more of the first through nineteenth aspects, the guard period/gap location defines that the guard period/gap starts from a first slot after an end of the reference symbol type switch boundary, or that the guard period/gap ends at an end of a last slot before a start of the reference symbol type switch boundary, depending on a symbol type combination.

In a twenty-first aspect, alone or in combination with one or more of the first through twentieth aspects, a gap duration associated with the guard period/gap is predefined in a specification, or is indicated by a network node based at least in part on a UE capability, based at least in part on the reference symbol type switch boundary being within the slot.

In a twenty-second aspect, alone or in combination with one or more of the first through twenty-first aspects, the guard period/gap is associated with a UE common time pattern or a UE dedicated time pattern, and the guard period/gap being defined in terms of a quantity of symbols or slots or a quantity of milliseconds depending on a subcarrier spacing, based at least in part on the reference symbol type switch boundary being within the slot.

In a twenty-third aspect, alone or in combination with one or more of the first through twenty-second aspects, the reference symbol type switch boundary is within the slot, based at least in part on explicit signaling from a network node.

In a twenty-fourth aspect, alone or in combination with one or more of the first through twenty-third aspects, the explicit signaling indicates an SFI or a TDD slot format pattern having a slot format as a gap slot, and indicating a corresponding slot format index per slot in a period of slots.

In a twenty-fifth aspect, alone or in combination with one or more of the first through twenty-fourth aspects, the explicit signaling indicates the guard period/gap location in an aperiodic pattern, the explicit signaling indicating one or more of a guard period/gap starting symbol location, a guard period/gap length, a time window starting symbol location, or a bitmap for symbols in a time window for the guard period/gap.

In a twenty-sixth aspect, alone or in combination with one or more of the first through twenty-fifth aspects, the guard period/gap is defined in a specification, indicated by a network node, or requested by a UE.

In a twenty-seventh aspect, alone or in combination with one or more of the first through twenty-sixth aspects, the guard period/gap is a quantity of symbols or slots, or a quantity of microseconds or milliseconds.

In a twenty-eighth aspect, alone or in combination with one or more of the first through twenty-seventh aspects, the guard period/gap is a common value or is associated with different values, depending on a switching of two types of symbols or slots and a transmit-receive direction.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram of an example apparatus 1400 for wireless communication, in accordance with the present disclosure. The apparatus 1400 may be a UE, or a UE may include the apparatus 1400. In some aspects, the apparatus 1400 includes a reception component 1402, a transmission component 1404, and/or a communication manager 1406, which may be in communication with one another (for example, via one or more buses and/or one or more other components). In some aspects, the communication manager 1406 is the communication manager 140 described in connection with FIG. 1. As shown, the apparatus 1400 may communicate with another apparatus 1408, such as a UE or a network node (such as a CU, a DU, an RU, or a base station), using the reception component 1402 and the transmission component 1404.

In some aspects, the apparatus 1400 may be configured to perform one or more operations described herein in connection with FIGS. 7-11. Additionally, or alternatively, the apparatus 1400 may be configured to perform one or more processes described herein, such as process 1200 of FIG. 12. In some aspects, the apparatus 1400 and/or one or more components shown in FIG. 14 may include one or more components of the UE described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1402 may receive communications, such as reference signals, control information, data communications, or a combination thereof, from the apparatus 1408. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, a modem, a demodulator, a MIMO detector, a receive processor, a controller/processor, a memory, or a combination thereof, of the UE described in connection with FIG. 2.

The transmission component 1404 may transmit communications, such as reference signals, control information, data communications, or a combination thereof, to the apparatus 1408. In some aspects, one or more other components of the apparatus 1400 may generate communications and may provide the generated communications to the transmission component 1404 for transmission to the apparatus 1408. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1408. In some aspects, the transmission component 1404 may include one or more antennas, a modem, a modulator, a transmit MIMO processor, a transmit processor, a controller/processor, a memory, or a combination thereof, of the UE described in connection with FIG. 2. In some aspects, the transmission component 1404 may be co-located with the reception component 1402 in a transceiver.

The communication manager 1406 may support operations of the reception component 1402 and/or the transmission component 1404. For example, the communication manager 1406 may receive information associated with configuring reception of communications by the reception component 1402 and/or transmission of communications by the transmission component 1404. Additionally, or alternatively, the communication manager 1406 may generate and/or provide control information to the reception component 1402 and/or the transmission component 1404 to control reception and/or transmission of communications.

The reception component 1402 and/or the transmission component 1404 may perform a first communication in a first type of symbol/slot. The reception component 1402 and/or the transmission component 1404 may perform a second communication in a second type of symbol/slot, a guard period/gap being defined between the first type of symbol/slot and the second type of symbol/slot, or the guard period/gap being defined within a slot corresponding to the first type of symbol/slot or the second type of symbol/slot, and the guard period/gap being defined based at least in part on a reference symbol type switch boundary and a guard period/gap location.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

FIG. 15 is a diagram of an example apparatus 1500 for wireless communication, in accordance with the present disclosure. The apparatus 1500 may be a network node, or a network node may include the apparatus 1500. In some aspects, the apparatus 1500 includes a reception component 1502, a transmission component 1504, and/or a communication manager 1506, which may be in communication with one another (for example, via one or more buses and/or one or more other components). In some aspects, the communication manager 1506 is the communication manager 150 described in connection with FIG. 1. As shown, the apparatus 1500 may communicate with another apparatus 1508, such as a UE or a network node (such as a CU, a DU, an RU, or a base station), using the reception component 1502 and the transmission component 1504.

In some aspects, the apparatus 1500 may be configured to perform one or more operations described herein in connection with FIGS. 7-11. Additionally, or alternatively, the apparatus 1500 may be configured to perform one or more processes described herein, such as process 1300 of FIG. 13. In some aspects, the apparatus 1500 and/or one or more components shown in FIG. 15 may include one or more components of the network node described in connection with FIG. 2. Additionally, or alternatively, one or more components shown in FIG. 15 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1502 may receive communications, such as reference signals, control information, data communications, or a combination thereof, from the apparatus 1508. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1500. In some aspects, the reception component 1502 may include one or more antennas, a modem, a demodulator, a MIMO detector, a receive processor, a controller/processor, a memory, or a combination thereof, of the network node described in connection with FIG. 2. In some aspects, the reception component 1502 and/or the transmission component 1504 may include or may be included in a network interface. The network interface may be configured to obtain and/or output signals for the apparatus 1500 via one or more communications links, such as a backhaul link, a midhaul link, and/or a fronthaul link.

The transmission component 1504 may transmit communications, such as reference signals, control information, data communications, or a combination thereof, to the apparatus 1508. In some aspects, one or more other components of the apparatus 1500 may generate communications and may provide the generated communications to the transmission component 1504 for transmission to the apparatus 1508. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1508. In some aspects, the transmission component 1504 may include one or more antennas, a modem, a modulator, a transmit MIMO processor, a transmit processor, a controller/processor, a memory, or a combination thereof, of the network node described in connection with FIG. 2. In some aspects, the transmission component 1504 may be co-located with the reception component 1502 in a transceiver.

The communication manager 1506 may support operations of the reception component 1502 and/or the transmission component 1504. For example, the communication manager 1506 may receive information associated with configuring reception of communications by the reception component 1502 and/or transmission of communications by the transmission component 1504. Additionally, or alternatively, the communication manager 1506 may generate and/or provide control information to the reception component 1502 and/or the transmission component 1504 to control reception and/or transmission of communications.

The reception component 1502 and/or the transmission component 1504 may perform a first communication in a first type of symbol/slot. The reception component 1502 and/or the transmission component 1504 may perform a second communication in a second type of symbol/slot, a guard period/gap being defined between the first type of symbol/slot and the second type of symbol/slot, or the guard period/gap being defined within a slot corresponding to the first type of symbol/slot or the second type of symbol/slot, and the guard period/gap being defined based at least in part on a reference symbol type switch boundary and a guard period/gap location.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

The following provides an overview of some Aspects of the present disclosure:

Aspect 1: A method of wireless communication performed by a user equipment (UE), comprising: performing a first communication in a first type of symbol or slot; and performing a second communication in a second type of symbol or slot, a guard period or gap being defined between the first type of symbol or slot and the second type of symbol or slot, or the guard period or gap being defined within a slot corresponding to the first type of symbol or slot or the second type of symbol or slot, and the guard period or gap being defined based at least in part on a reference symbol type switch boundary and a guard period or gap location.

Aspect 2: The method of Aspect 1, wherein: the first type of symbol or slot is a subband full-duplex (SBFD) symbol or slot, and the second type of symbol or slot is a non-SBFD downlink, uplink, or flexible symbol or slot; or the first type of symbol or slot is the non-SBFD downlink, uplink, or flexible symbol or slot, and the second type of symbol or slot is the SBFD symbol or slot.

Aspect 3: The method of any of Aspects 1-2, wherein the reference symbol type switch boundary corresponds to a slot boundary of the first type of symbol or slot, or the second type of symbol or slot, based at least in part on an implicit rule for the guard period or gap.

Aspect 4: The method of Aspect 3, wherein the guard period or gap location defines that the guard period or gap starts at an end of the reference symbol type switch boundary.

Aspect 5: The method of Aspect 3, wherein the guard period or gap location defines that the guard period or gap ends at a start of the reference symbol type switch boundary.

Aspect 6: The method of Aspect 3, wherein the guard period or gap location defines that the guard period or gap is across the reference symbol type switch boundary.

Aspect 7: The method of Aspect 3, wherein the guard period or gap location defines that the guard period or gap is within a subband full duplex (SBFD) slot or in a non-SBFD slot.

Aspect 8: The method of Aspect 3, wherein the guard period or gap location defines that the guard period or gap starts at an end of the reference symbol type switch boundary, or that the guard period or gap ends at a start of the reference symbol type switch boundary, depending on a symbol type combination.

Aspect 9: The method of Aspect 8, wherein: the guard period or gap location defines that the guard period or gap starts from the end of the reference symbol type switch boundary, based at least in part on the symbol type combination corresponding to a subband full duplex (SBFD) symbol followed by a non-SBFD symbol; or the guard period or gap location defines that the guard period or gap ends at the start of the reference symbol type switch boundary, based at least in part on the symbol type combination corresponding to a non-SBFD symbol followed by an SBFD symbol.

Aspect 10: The method of Aspect 3, wherein a gap duration associated with the guard period or gap is predefined in a specification, or is indicated by a network node based at least in part on a UE capability, based at least in part on the reference symbol type switch boundary corresponding to the slot boundary.

Aspect 11: The method of Aspect 3, wherein the guard period or gap is associated with a UE common time pattern or a UE dedicated time pattern, and the guard period or gap being defined in terms of a quantity of symbols or slots or a quantity of milliseconds depending on a subcarrier spacing, based at least in part on the reference symbol type switch boundary corresponding to the slot boundary.

Aspect 12: The method of any of Aspects 1-11, wherein the reference symbol type switch boundary corresponds to a slot boundary of the first type of symbol or slot, or a slot boundary of the second type of symbol or slot, based at least in part on explicit signaling from a network node.

Aspect 13: The method of Aspect 12, wherein the explicit signaling indicates a periodic subband full duplex (SBFD) time pattern or a semi-persistent SBFD time pattern, the periodic SBFD time pattern or the semi-persistent SBFD time pattern indicating whether a symbol or slot is a gap symbol or slot.

Aspect 14: The method of Aspect 12, wherein the explicit signaling indicates the guard period or gap location in an aperiodic pattern, the explicit signaling indicating one or more of: a guard period or gap starting symbol location, a guard period or gap length, a time window starting symbol location, or a bitmap for symbols in a time window for the guard period or gap.

Aspect 15: The method of any of Aspects 1-14, wherein the reference symbol type switch boundary is within the slot.

Aspect 16: The method of Aspect 15, wherein the guard period or gap is in terms of a quantity of symbols less than a slot duration, a guard period or gap start time and a guard period or gap end time being in any symbol boundary within the slot.

Aspect 17: The method of Aspect 15, wherein the guard period or gap is in terms of a quantity of slots larger than a slot duration, a guard period or gap start time and a guard period or gap end time corresponding to a slot boundary.

Aspect 18: The method of Aspect 15, wherein the reference symbol type switch boundary is within the slot, based at least in part on an implicit rule for the guard period or gap.

Aspect 19: The method of Aspect 18, wherein the guard period or gap location defines that the guard period or gap starts from a first slot after an end of the reference symbol type switch boundary.

Aspect 20: The method of Aspect 18, wherein the guard period or gap location defines that the guard period or gap ends at an end of a last slot before a start of the reference symbol type switch boundary.

Aspect 21: The method of Aspect 18, wherein the guard period or gap location defines that the guard period or gap starts from a first slot after an end of the reference symbol type switch boundary, or that the guard period or gap ends at an end of a last slot before a start of the reference symbol type switch boundary, depending on a symbol type combination.

Aspect 22: The method of Aspect 15, wherein a gap duration associated with the guard period or gap is predefined in a specification, or is indicated by a network node based at least in part on a UE capability, based at least in part on the reference symbol type switch boundary being within the slot.

Aspect 23: The method of Aspect 15, wherein the guard period or gap is associated with a UE common time pattern or a UE dedicated time pattern, and the guard period or gap being defined in terms of a quantity of symbols or slots or a quantity of milliseconds depending on a subcarrier spacing, based at least in part on the reference symbol type switch boundary being within the slot.

Aspect 24: The method of Aspect 15, wherein the reference symbol type switch boundary is within the slot, based at least in part on explicit signaling from a network node.

Aspect 25: The method of Aspect 24, wherein the explicit signaling indicates a slot format indicator (SFI) or a time division duplexing (TDD) slot format pattern having a slot format as a gap slot, and indicating a corresponding slot format index per slot in a period of slots.

Aspect 26: The method of Aspect 24, wherein the explicit signaling indicates the guard period or gap location in an aperiodic pattern, the explicit signaling indicating one or more of: a guard period or gap starting symbol location, a guard period or gap length, a time window starting symbol location, or a bitmap for symbols in a time window for the guard period or gap.

Aspect 27: The method of any of Aspects 1-26, wherein the guard period or gap is defined in a specification, indicated by a network node, or requested by the UE.

Aspect 28: The method of any of Aspects 1-27, wherein the guard period or gap is a quantity of symbols or slots, or a quantity of microseconds or milliseconds.

Aspect 29: The method of any of Aspects 1-28, wherein the guard period or gap is a common value or is associated with different values, depending on a switching of two types of symbols or slots and a transmit-receive direction.

Aspect 30: The method of any of Aspects 1-29, wherein the UE is a subband full duplex (SBFD)-aware UE and is not expected to perform communications in the guard period or gap.

Aspect 31: A method of wireless communication performed by a network node, comprising: performing a first communication in a first type of symbol or slot; and performing a second communication in a second type of symbol or slot, a guard period or gap being defined between the first type of symbol or slot and the second type of symbol or slot, or the guard period or gap being defined within a slot corresponding to the first type of symbol or slot or the second type of symbol or slot, and the guard period or gap being defined based at least in part on a reference symbol type switch boundary and a guard period or gap location.

Aspect 32: The method of Aspect 31, wherein: the first type of symbol or slot is a subband full-duplex (SBFD) symbol or slot, and the second type of symbol or slot is a non-SBFD downlink, uplink, or flexible symbol or slot; or the first type of symbol or slot is the non-SBFD downlink, uplink, or flexible symbol or slot, and the second type of symbol or slot is the SBFD symbol or slot.

Aspect 33: The method of any of Aspects 31-32, wherein the reference symbol type switch boundary corresponds to a slot boundary of the first type of symbol or slot, or the second type of symbol or slot, based at least in part on an implicit rule for the guard period or gap.

Aspect 34: The method of Aspect 33, wherein the guard period or gap location defines that the guard period or gap starts at an end of the reference symbol type switch boundary.

Aspect 35: The method of Aspect 33, wherein the guard period or gap location defines that the guard period or gap ends at a start of the reference symbol type switch boundary.

Aspect 36: The method of Aspect 33, wherein the guard period or gap location defines that the guard period or gap is across the reference symbol type switch boundary.

Aspect 37: The method of Aspect 33, wherein the guard period or gap location defines that the guard period or gap is within a subband full duplex (SBFD) slot or in a non-SBFD slot.

Aspect 38: The method of Aspect 33, wherein the guard period or gap location defines that the guard period or gap starts at an end of the reference symbol type switch boundary, or that the guard period or gap ends at a start of the reference symbol type switch boundary, depending on a symbol type combination.

Aspect 39: The method of Aspect 38, wherein: the guard period or gap location defines that the guard period or gap starts from the end of the reference symbol type switch boundary, based at least in part on the symbol type combination corresponding to a subband full duplex (SBFD) symbol followed by a non-SBFD symbol; or the guard period or gap location defines that the guard period or gap ends at the start of the reference symbol type switch boundary, based at least in part on the symbol type combination corresponding to a non-SBFD symbol followed by an SBFD symbol.

Aspect 40: The method of Aspect 33, wherein a gap duration associated with the guard period or gap is predefined in a specification, or is indicated by a network node based at least in part on a UE capability, based at least in part on the reference symbol type switch boundary corresponding to the slot boundary.

Aspect 41: The method of Aspect 33, wherein the guard period or gap is associated with a user equipment (UE) common time pattern or a UE dedicated time pattern, and the guard period or gap being defined in terms of a quantity of symbols or slots or a quantity of milliseconds depending on a subcarrier spacing, based at least in part on the reference symbol type switch boundary corresponding to the slot boundary.

Aspect 42: The method of any of Aspects 31-41, wherein the reference symbol type switch boundary corresponds to a slot boundary of the first type of symbol or slot, or a slot boundary of the second type of symbol or slot, based at least in part on explicit signaling from a network node.

Aspect 43: The method of Aspect 42, wherein the explicit signaling indicates a periodic subband full duplex (SBFD) time pattern or a semi-persistent SBFD time pattern, the periodic SBFD time pattern or the semi-persistent SBFD time pattern indicating whether a symbol or slot is a gap symbol or slot.

Aspect 44: The method of Aspect 42, wherein the explicit signaling indicates the guard period or gap location in an aperiodic pattern, the explicit signaling indicating one or more of: a guard period or gap starting symbol location, a guard period or gap length, a time window starting symbol location, or a bitmap for symbols in a time window for the guard period or gap.

Aspect 45: The method of any of Aspects 31-44, wherein the reference symbol type switch boundary is within the slot.

Aspect 46: The method of Aspect 45, wherein the guard period or gap is in terms of a quantity of symbols less than a slot duration, a guard period or gap start time and a guard period or gap end time being in any symbol boundary within the slot.

Aspect 47: The method of Aspect 45, wherein the guard period or gap is in terms of a quantity of slots larger than a slot duration, a guard period or gap start time and a guard period or gap end time corresponding to a slot boundary.

Aspect 48: The method of Aspect 45, wherein the reference symbol type switch boundary is within the slot, based at least in part on an implicit rule for the guard period or gap.

Aspect 49: The method of Aspect 48, wherein the guard period or gap location defines that the guard period or gap starts from a first slot after an end of the reference symbol type switch boundary.

Aspect 50: The method of Aspect 48, wherein the guard period or gap location defines that the guard period or gap ends at an end of a last slot before a start of the reference symbol type switch boundary.

Aspect 51: The method of Aspect 48, wherein the guard period or gap location defines that the guard period or gap starts from a first slot after an end of the reference symbol type switch boundary, or that the guard period or gap ends at an end of a last slot before a start of the reference symbol type switch boundary, depending on a symbol type combination.

Aspect 52: The method of Aspect 45, wherein a gap duration associated with the guard period or gap is predefined in a specification, or is indicated by a network node based at least in part on a UE capability, based at least in part on the reference symbol type switch boundary being within the slot.

Aspect 53: The method of Aspect 45, wherein the guard period or gap is associated with a user equipment (UE) common time pattern or a UE dedicated time pattern, and the guard period or gap being defined in terms of a quantity of symbols or slots or a quantity of milliseconds depending on a subcarrier spacing, based at least in part on the reference symbol type switch boundary being within the slot.

Aspect 54: The method of Aspect 45, wherein the reference symbol type switch boundary is within the slot, based at least in part on explicit signaling from a network node.

Aspect 55: The method of Aspect 54, wherein the explicit signaling indicates a slot format indicator (SFI) or a time division duplexing (TDD) slot format pattern having a slot format as a gap slot, and indicating a corresponding slot format index per slot in a period of slots.

Aspect 56: The method of Aspect 54, wherein the explicit signaling indicates the guard period or gap location in an aperiodic pattern, the explicit signaling indicating one or more of: a guard period or gap starting symbol location, a guard period or gap length, a time window starting symbol location, or a bitmap for symbols in a time window for the guard period or gap.

Aspect 57: The method of any of Aspects 31-56, wherein the guard period or gap is defined in a specification, indicated by a network node, or requested by the UE.

Aspect 58: The method of any of Aspects 31-57, wherein the guard period or gap is a quantity of symbols or slots, or a quantity of microseconds or milliseconds.

Aspect 59: The method of any of Aspects 31-58, wherein the guard period or gap is a common value or is associated with different values, depending on a switching of two types of symbols or slots and a transmit-receive direction.

Aspect 60: An apparatus for wireless communication at a device, comprising a processor; memory coupled with the processor; and instructions stored in the memory and executable by the processor to cause the apparatus to perform the method of one or more of Aspects 1-30.

Aspect 61: A device for wireless communication, comprising a memory and one or more processors coupled to the memory, the one or more processors configured to perform the method of one or more of Aspects 1-30.

Aspect 62: An apparatus for wireless communication, comprising at least one means for performing the method of one or more of Aspects 1-30.

Aspect 63: A non-transitory computer-readable medium storing code for wireless communication, the code comprising instructions executable by a processor to perform the method of one or more of Aspects 1-30.

Aspect 64: A non-transitory computer-readable medium storing a set of instructions for wireless communication, the set of instructions comprising one or more instructions that, when executed by one or more processors of a device, cause the device to perform the method of one or more of Aspects 1-30.

Aspect 65: An apparatus for wireless communication at a device, comprising a processor; memory coupled with the processor; and instructions stored in the memory and executable by the processor to cause the apparatus to perform the method of one or more of Aspects 31-59.

Aspect 66: A device for wireless communication, comprising a memory and one or more processors coupled to the memory, the one or more processors configured to perform the method of one or more of Aspects 31-59.

Aspect 67: An apparatus for wireless communication, comprising at least one means for performing the method of one or more of Aspects 31-59.

Aspect 68: A non-transitory computer-readable medium storing code for wireless communication, the code comprising instructions executable by a processor to perform the method of one or more of Aspects 31-59.

Aspect 69: A non-transitory computer-readable medium storing a set of instructions for wireless communication, the set of instructions comprising one or more instructions that, when executed by one or more processors of a device, cause the device to perform the method of one or more of Aspects 31-59.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a memory; and
one or more processors, coupled to the memory, configured to:
perform a first communication in a first type of symbol or slot; and
perform a second communication in a second type of symbol or slot,
a guard period or gap being defined between the first type of symbol or slot and the second type of symbol or slot, or the guard period or gap being defined within a slot corresponding to the first type of symbol or slot or the second type of symbol or slot, and the guard period or gap being defined based at least in part on a reference symbol type switch boundary and a guard period or gap location.

2. The apparatus of claim 1, wherein:
the first type of symbol or slot is a subband full-duplex (SBFD) symbol or slot, and the second type of symbol or slot is a non-SBFD downlink, uplink, or flexible symbol or slot; or
the first type of symbol or slot is the non-SBFD downlink, uplink, or flexible symbol or slot, and the second type of symbol or slot is the SBFD symbol or slot.

3. The apparatus of claim 1, wherein the reference symbol type switch boundary corresponds to a slot boundary of the first type of symbol or slot, or the second type of symbol or slot, based at least in part on an implicit rule for the guard period or gap.

4. The apparatus of claim 3, wherein the guard period or gap location defines that the guard period or gap starts at an end of the reference symbol type switch boundary.

5. The apparatus of claim 3, wherein the guard period or gap location defines that the guard period or gap ends at a start of the reference symbol type switch boundary.

6. The apparatus of claim 3, wherein the guard period or gap location defines that the guard period or gap is across the reference symbol type switch boundary.

7. The apparatus of claim 3, wherein the guard period or gap location defines that the guard period or gap is within a subband full duplex (SBFD) slot or in a non-SBFD slot.

8. The apparatus of claim 3, wherein the guard period or gap location defines that the guard period or gap starts at an end of the reference symbol type switch boundary, or that the guard period or gap ends at a start of the reference symbol type switch boundary, depending on a symbol type combination.

9. The apparatus of claim 8, wherein:
the guard period or gap location defines that the guard period or gap starts from the end of the reference symbol type switch boundary, based at least in part on the symbol type combination corresponding to a subband full duplex (SBFD) symbol followed by a non-SBFD symbol; or
the guard period or gap location defines that the guard period or gap ends at the start of the reference symbol type switch boundary, based at least in part on the symbol type combination corresponding to a non-SBFD symbol followed by an SBFD symbol.

10. The apparatus of claim 3, wherein a gap duration associated with the guard period or gap is predefined in a specification, or is indicated by a network node based at least in part on a UE capability, based at least in part on the reference symbol type switch boundary corresponding to the slot boundary.

11. The apparatus of claim 3, wherein the guard period or gap is associated with a UE common time pattern or a UE dedicated time pattern, and the guard period or gap being defined in terms of a quantity of symbols or slots or a quantity of milliseconds depending on a subcarrier spacing, based at least in part on the reference symbol type switch boundary corresponding to the slot boundary.

12. The apparatus of claim 1, wherein the reference symbol type switch boundary corresponds to a slot boundary of the first type of symbol or slot, or a slot boundary of the second type of symbol or slot, based at least in part on explicit signaling from a network node.

13. The apparatus of claim 12, wherein the explicit signaling indicates a periodic subband full duplex (SBFD) time pattern or a semi-persistent SBFD time pattern, the periodic SBFD time pattern or the semi-persistent SBFD time pattern indicating whether a symbol or slot is a gap symbol or slot.

14. The apparatus of claim 12, wherein the explicit signaling indicates the guard period or gap location in an aperiodic pattern, the explicit signaling indicating one or more of: a guard period or gap starting symbol location, a guard period or gap length, a time window starting symbol location, or a bitmap for symbols in a time window for the guard period or gap.

15. The apparatus of claim 1, wherein the reference symbol type switch boundary is within the slot.

16. The apparatus of claim 15, wherein the guard period or gap is in terms of a quantity of symbols less than a slot duration, a guard period or gap start time and a guard period or gap end time being in any symbol boundary within the slot.

17. The apparatus of claim 15, wherein the guard period or gap is in terms of a quantity of slots larger than a slot duration, a guard period or gap start time and a guard period or gap end time corresponding to a slot boundary.

18. The apparatus of claim 15, wherein the reference symbol type switch boundary is within the slot, based at least in part on an implicit rule for the guard period or gap.

19. The apparatus of claim 18, wherein the guard period or gap location defines that the guard period or gap starts from a first slot after an end of the reference symbol type switch boundary.

20. The apparatus of claim 18, wherein the guard period or gap location defines that the guard period or gap ends at an end of a last slot before a start of the reference symbol type switch boundary.

21. The apparatus of claim 18, wherein the guard period or gap location defines that the guard period or gap starts from a first slot after an end of the reference symbol type switch boundary, or that the guard period or gap ends at an end of a last slot before a start of the reference symbol type switch boundary, depending on a symbol type combination.

22. The apparatus of claim 15, wherein a gap duration associated with the guard period or gap is predefined in a specification, or is indicated by a network node based at least in part on a UE capability, based at least in part on the reference symbol type switch boundary being within the slot.

23. The apparatus of claim 15, wherein the guard period or gap is associated with a UE common time pattern or a UE dedicated time pattern, and the guard period or gap being defined in terms of a quantity of symbols or slots or a quantity of milliseconds depending on a subcarrier spacing, based at least in part on the reference symbol type switch boundary being within the slot.

24. The apparatus of claim 15, wherein the reference symbol type switch boundary is within the slot, based at least in part on explicit signaling from a network node.

25. The apparatus of claim 24, wherein:
the explicit signaling indicates a slot format indicator (SFI) or a time division duplexing (TDD) slot format pattern having a slot format as a gap slot, and indicating a corresponding slot format index per slot in a period of slots; or
the explicit signaling indicates the guard period or gap location in an aperiodic pattern, the explicit signaling indicating one or more of: a guard period or gap starting symbol location, a guard period or gap length, a time window starting symbol location, or a bitmap for symbols in a time window for the guard period or gap.

26. The apparatus of claim 1, wherein:
the guard period or gap is defined in a specification, indicated by a network node, or requested by the UE; or
the guard period or gap is a common value or is associated with different values, depending on a switching of two types of symbols or slots and a transmit-receive direction.

27. The apparatus of claim 1, wherein the UE is a subband full duplex (SBFD)-aware UE and is not expected to perform communications in the guard period or gap.

28. An apparatus for wireless communication at a network node, comprising:
a memory; and
one or more processors, coupled to the memory, configured to:
perform a first communication in a first type of symbol or slot; and
perform a second communication in a second type of symbol or slot,
a guard period or gap being defined between the first type of symbol or slot and the second type of symbol or slot, or the guard period or gap being defined within a slot corresponding to the first type of symbol or slot or the second type of symbol or slot, and the guard period or gap being defined based at least in part on a reference symbol type switch boundary and a guard period or gap location.

29. A method of wireless communication performed by a user equipment (UE), comprising:
performing a first communication in a first type of symbol or slot; and
performing a second communication in a second type of symbol or slot,
a guard period or gap being defined between the first type of symbol or slot and the second type of symbol or slot, or the guard period or gap being defined within a slot corresponding to the first type of symbol or slot or the second type of symbol or slot, and the guard period or gap being defined based at least in part on a reference symbol type switch boundary and a guard period or gap location.

30. A method of wireless communication performed by a network node, comprising:
performing a first communication in a first type of symbol or slot; and
performing a second communication in a second type of symbol or slot,
a guard period or gap being defined between the first type of symbol or slot and the second type of symbol or slot, or the guard period or gap being defined within a slot corresponding to the first type of symbol or slot or the second type of symbol or slot, and the guard period or gap being defined based at least in part on a reference symbol type switch boundary and a guard period or gap location.
